(19) United States
(12) Patent Application Publication
(10) Pub. No.: US 2013/0060689 A1
(43) Pub. Date: Mar. 7, 2013

(54) ELECTRONIC MONEY TRANSFER SERVICE

(71) Applicants: Ilya Oskolkov, Moscow (RU); Rodion Shishkov, St. Petersburg (RU)

(72) Inventors: Ilya Oskolkov, Moscow (RU); Rodion Shishkov, St. Petersburg (RU)

(73) Assignee: RAWLLIN INTERNATIONAL INC., Tortola (VG)

(21) Appl. No.: 13/226,373

(22) Filed: Sep. 6, 2011

(51) Int. Cl. G06Q 40/00

(52) U.S. Cl. 705/42

(57) ABSTRACT

Techniques for efficient transfer of funds between parties using personal communication devices are presented. A first user can use a first communication device to transfer funds from an account associated with the first user to a second user via a communication address associated with the second user's second communication device even if the second user is not registered with a financial service provider associated with the account of the first user. The funds can be sent from the first communication device using the Internet, mobile communication systems, or other communication technology via a message, an email, a voice mail, etc., to the second user, wherein notification of the funds can be sent to the second communication device. The first user can send funds using an account with the financial service provider or an affiliated account, and the second user can have the funds deposited into a desired account.

### TECHNICAL FIELD

This disclosure relates generally to data communications, and more specifically to electronic money transfers via a communication network.

### BACKGROUND

Occasionally an individual desires or needs to transfer monetary funds to another person, including instances where the other person is located far away from the individual thereby making it difficult for the individual to transfer the monetary funds to the other person. For many years, people have been able to “wire” monetary funds via communication networks. With recent improvements in communication technology, it has been possible to use communication devices, such as personal computers and mobile phones, via the Internet, mobile communication networks and other communication technology, to transfer monetary funds.

For example, an individual can register a bank account online and can make payment on bills to creditors using a computer or mobile phone. As another example, using a computer or mobile phone, the individual also can transfer monetary funds from one bank account to another bank account (e.g., another bank account of the individual or another bank account of another person) so long as both of those bank accounts are online and the individual knows the account information of the receiving bank account. As still another example, an individual can use a communication device to transfer monetary funds from the individual's account associated with a financial services provider (e.g., a bank account or an online account with a financial services provider) to another person so long as both the individual or other person have registered with the financial services provider.

However, conventional systems and methods for transferring monetary funds have drawbacks. For instance, conventionally both the individual who is sending money and the other person receiving the money have to be registered with a financial entity, such as a financial services provider, in order for the individual and other person to be able to use their respective computers or mobile phones to perform the monetary transfer.

Today, there is no way to effectively manage electronic monetary transfers between an individual sending money and another person receiving the money using their respective personal communication devices, for instance, when both the individual and the other person do not have a registered account associated with a financial entity. The above-described deficiencies of today's systems are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

The following presents a simplified summary of various aspects of the disclosed subject matter in order to provide a basic understanding of such aspects. This summary is not an extensive overview of all contemplated aspects, and is intended to neither identify key or critical elements nor delineate the scope of such aspects. Its sole purpose is to present some concepts of the disclosed subject matter in a simplified form as a prelude to the more detailed description that is presented later.

Techniques for efficient transfer of funds between parties using personal communication devices are presented herein. In an aspect, a transfer management component (TMC) can be employed to control fund transfers (e.g., money transfers) between parties associated with a communication network. The TMC can manage a fund transfer, wherein the funds can be withdrawn from an account associated with a first user, when the first user uses the first user's first communication device to transfer funds to a second user via a communication address associated with the second user's second communication device (e.g., email address, phone number or social networking address, associated with the second user's second communication device), even if the second user is not registered with a financial service provider associated with the account of the first user (e.g., the funds can be pushed to the second user even if the user is not associated with the transfer system). The funds can be sent from the first communication device using an Internet Protocol (IP)-based network (e.g., the Internet), mobile communication systems (e.g., mobile core network), or other communication technology via a message (e.g., email, text message, multimedia message, instant message, voice mail message, message via a social network, voice mail, etc.) to the second user, wherein notification (e.g., via the message) of the funds can be sent to the second communication device. The first user can transfer the funds using a financial account with the financial service provider or an affiliated financial account (e.g., other registered financial account), and the second user can have the funds deposited into a desired financial account, which can be specified by the second user via the second communication device in response to receiving the message and/or, if the second user is registered with the financial service provider, to a predefined or default financial account (e.g., a financial account previously registered with the financial service provider).

In accordance with other aspects, the TMC also can enable a user to manually transfer funds between the financial service provider and other third-party financial accounts of the user (e.g., associated with third-party institutions), and/or enable the user to transfers to other accounts, such as accounts associated with utility services, credit cards, or other types of service or product providers. In accordance with still other aspects, the TMC can efficiently manage financial transactions (e.g., transfer of funds) between a user and businesses (e.g., taxi drivers, brick-and-mortar businesses, online businesses, etc.) via, for example, pull payments.

In accordance with another aspect, the disclosed subject matter can include a system that can comprise a communication device associated with a money transfer service and configured to transmit a fund transfer message to a destination associated with a payee to notify the payee of a fund transfer from a payer. The system can also include a TMC associated with the communication device and configured to receive a fund transfer request from a payer communication device associated with the payer, generate the fund transfer message to facilitate transfer of a specified amount of funds from an account associated with the payer to the payee, without the payee having to be registered with the money transfer service.

In accordance with an aspect, the disclosed subject matter can include a method comprising: employing at least one processor to facilitate execution of code instructions retained in a memory, the code instructions, in response to execution, perform acts comprising: receiving a transfer fund request from a first communication device, wherein the transfer fund request requests a specified amount of funds be withdrawn from an account associated with the first communication device and transferred to a destination associated with an intended recipient; and transmitting a message, comprising information relating to the transfer fund request, to the destination associated with the intended recipient to facilitate transferring the specified amount of funds to the intended recipient, based at least in part on authentication information received by a TMC from the intended recipient, even if the intended recipient is not registered with the TMC.

In accordance with a further aspect, the disclosed subject matter can comprise a computer program product comprising a computer readable storage medium having computer executable instructions stored thereon that, in response to execution, cause a computing system to perform operations, comprising: receiving a transfer fund request from a first communication device, wherein the transfer fund request requests a specified amount of funds be withdrawn from an account associated with the first communication device and transferred to a destination associated with an intended recipient; and transmitting a message, comprising information relating to the transfer fund request, to the destination associated with the intended recipient to facilitate transferring the specified amount of funds to the intended recipient, based at least in part on authentication information received by a TMC from the intended recipient, even if the intended recipient is not registered with the TMC.

In still another aspect, the disclosed subject matter can include a communication device. The communication device can comprise a user interface configured to display information associated with a transfer of funds to be processed by a money transfer service. The communication device also can comprise a mobile TMC configured to generate and transmit a fund transfer request to transfer the funds from an account of a payer that is registered with the money transfer service to a payee, wherein the fund transfer request is able to be processed to transfer the funds to the payee even if the payee is not registered with the money transfer service.

The following description and the annexed drawings set forth in detail certain illustrative aspects of the disclosed subject matter. These aspects are indicative, however, of but a few of the various ways in which the principles of the disclosed subject matter may be employed. The disclosed subject matter is intended to include all such aspects and their equivalents. Other advantages and distinctive features of the disclosed subject matter will become apparent from the following detailed description of the disclosed subject matter when considered in conjunction with the drawings.

### BRIEF DESCRIPTION OF THE DRAWINGS

FIG. 1 illustrates a block diagram of an example system that can manage transfer of property (e.g., monetary funds) between users using communication devices associated with the users in accordance with various aspects and embodiments described herein.

FIG. 2 depicts a block diagram of an example communication device in accordance with various aspects and embodiments of the disclosed subject matter.

FIG. 3 illustrates a block diagram of an example transfer management component (TMC) in accordance with various aspects and embodiments of the disclosed subject matter.

FIG. 4 illustrates a block diagram of example system that can facilitate money transfers in accordance with various aspects and embodiments of the disclosed subject matter.

FIG. 5 depicts a diagram of an example fund transfer message generation flow that can facilitate generating and sending a fund transfer request using a web or mobile Money Transfer Service (MTS) application interface in accordance with various aspects of the disclosed subject matter.

FIG. 6 illustrates a block diagram of an example fund transfer message receipt flow that can facilitate receiving and obtaining funds associated with a fund transfer message using a web or mobile MTS application interface in accordance with various aspects of the disclosed subject matter.

FIG. 7 illustrates a block diagram of an example fund transfer message receipt flow that can facilitate receiving and obtaining funds associated with a fund transfer message using a message application interface in accordance with various aspects of the disclosed subject matter.

FIG. 8 illustrates a flow diagram of an example method for transferring money using personal communication devices, in accordance with various aspects and embodiments.

FIG. 9 depicts a flow diagram of an example method for managing monetary transfers in accordance with various aspects and embodiments.

FIG. 10 presents a flow diagram of an example method for manually depositing funds into or withdrawing funds from an account associated with a user in accordance with various aspects and embodiments.

FIG. 11 is a flow diagram of an example method for automatically depositing funds into or withdrawing funds from an account associated with a user in accordance with various aspects and embodiments.

FIG. 12 is a flow diagram of an example method for managing an account associated with service account of a user in accordance with various aspects and embodiments.

FIG. 13 presents a flow diagram of an example method for sending funds via a message interface associated with a service account associated with a user in accordance with various aspects and embodiments.

FIG. 14 depicts a flow diagram of an example method for transferring funds via an application interface (e.g., web or mobile application interface) associated with a service account associated with a user in accordance with various aspects and embodiments.

FIG. 15 is a flow diagram of an example method for transferring funds via an application interface (e.g., web or mobile application interface) associated with a service account associated with a user in accordance with various aspects and embodiments.

FIG. 16 is a flow diagram of an example method for transferring funds via an application interface (e.g., web or mobile application interface) associated with a service account associated with a user in relation to a MTS in accordance with various aspects and embodiments.

FIG. 17 illustrates a flow diagram of an example method for transferring funds associated with a service account associated with a payer in relation to an MTS in accordance with various aspects and embodiments.

FIG. 18 depicts a flow diagram of an example method for receiving transferred funds associated with a service account of an intended recipient using an MTS (and related web or mobile MTS application) in accordance with various aspects and embodiments.

FIG. 19 is a diagram of an example wireless communication device in accordance with various aspects and embodiments of the disclosed subject matter.

FIG. 20 is a schematic block diagram illustrating a suitable operating environment.

FIG. 21 is a schematic block diagram of a sample-computing environment.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

Techniques for efficient transfer of funds between parties using personal communication devices are presented herein. In an aspect, a transfer management component can be employed to control fund transfers (e.g., money transfers) between parties associated with a communication network, wherein the transfer management component can be associated with a money transfer service. The transfer management component can manage a fund transfer, wherein the funds to be transferred can be withdrawn from an account (e.g., service account) associated with a first user, when the first user uses the first user's first communication device to transfer funds to a second user via a communication address associated with the second user's second communication device (e.g., email address, phone number or social networking address, associated with the second user's second communication device), even if the second user is not registered with a financial service provider associated with the account of the first user (e.g., the funds can be pushed to the second user even if the user is not associated with the transfer system). The funds can be sent from the first communication device using an Internet Protocol (IP)-based network (e.g., the Internet), mobile communication systems (e.g., mobile core network), or other communication technology via a message (e.g., email, text message, multimedia message, instant message, voice mail message, message via a social network, voice mail, etc.) to the second user, wherein notification (e.g., via the message) of the funds can be sent to the second communication device. The first user can transfer the funds using a financial account with the financial service provider or an affiliated financial account (e.g., other registered financial account), and the second user can have the funds deposited into a desired financial account, which can be specified by the second user via the second communication device in response to receiving the message and/or, if the second user is registered with the financial service provider, to a predefined or default financial account (e.g., a financial account previously registered with the financial service provider).

In accordance with other aspects, the transfer management component also can enable a user to manually transfer funds between the financial service provider and other third-party financial accounts of the user (e.g., associated with third-party institutions), and/or enable the user to transfers to other accounts, such as accounts associated with utility services, credit cards, or other types of service or product providers. In accordance with still other aspects, the transfer management component can efficiently manage financial transactions (e.g., transfer of funds) between a user and businesses (e.g., taxi drivers, brick-and-mortar businesses, online businesses, etc.) via, for example, pull payments.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “mobile station,” “mobile,” “wireless device,” “wireless communication device,” “access terminal,” “terminal,” and similar terminology are used herein to refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the term “access point” (AP), can be or can comprise a base station, Node B, Evolved Node B (eNode B or eNB), Home Node B (HNB), home access point (HAP), and can refer to a wireless network component or appliance that serves and receives data, control, voice, video, sound, gaming, or substantially any data-stream or signaling-stream from a set of subscriber stations. Data and signaling streams can be packetized or frame-based flows.

Furthermore, the terms “user,” “subscriber,” and the like are employed interchangeably throughout the subject specification, unless context warrants particular distinction(s) among the terms. It should be appreciated that such terms can refer to human entities or automated components supported through artificial intelligence (e.g., a capacity to make inference based on complex mathematical formalisms), which can provide simulated vision, sound recognition and so forth.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

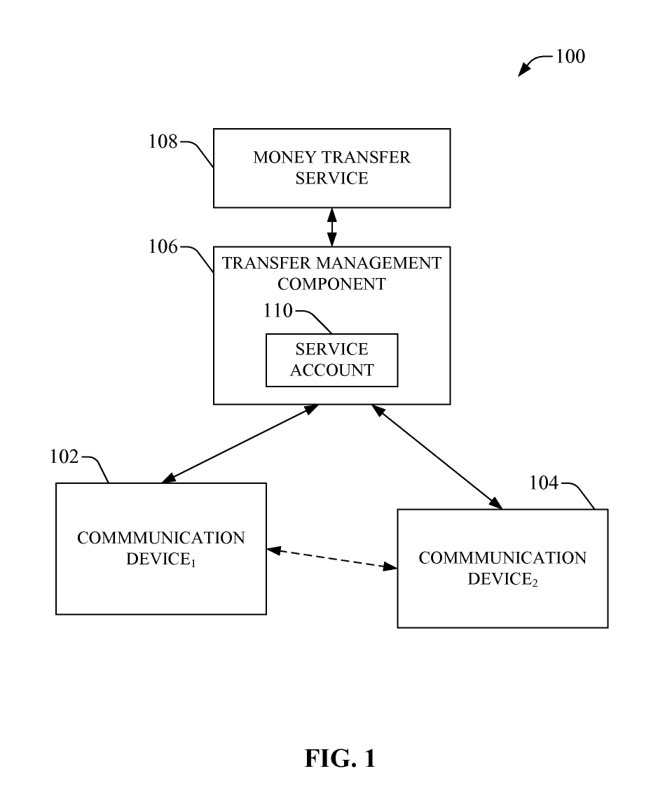

Referring now to the drawings, FIG. 1 illustrates a block diagram of an example system 100 that can manage transfer of property (e.g., monetary funds) between users using communication devices associated with the users in accordance with various aspects and embodiments described herein. While the disclosed subject matter will often be described herein with regard to the transfer of monetary funds, the disclosed subject matter is not so limited, as other property (e.g., credit line, electronic items of property, etc.) also can be transferred in accordance with the aspects and embodiments disclosed herein.

In an aspect, the system 100 can include a first communication device 102 (also referred to as communication device₁), which can be associated with a first user, and a second communication device 104 (also referred to as communication device₂), which can be associated with a second user. The first communication device 102 and second communication device 104 each can be a wired or wireless communication device, such as, for example, a mobile or wireless communication device (e.g., a mobile phone and/or smart phone), a personal digital assistant (PDA), a computer (e.g., laptop computer), a set-top box, an electronic notebook, an electronic pad or tablet (e.g., iPad), a portable electronic gaming device, a landline phone with messaging capabilities (e.g., voice mail, mobile messaging capabilities (e.g., text message, instant message, multimedia message, etc.)), etc. For example, the first communication device 102 can be a device used by a first user (e.g., payer or sender), who desires to use the first communication device 102 to send monetary funds to the second user (e.g., payee, intended recipient, receiver), wherein the second user can obtain or manage the monetary funds using the second communication device 104.

In accordance with various aspects and embodiments, the system 100 can comprise a transfer management component (TMC) 106 that can be communicatively connected, at least at certain times, to the first communication device 102 and/or second communication device 104 to facilitate efficiently transferring funds between accounts (e.g., mobile service financial account, such as a Money Transfer Service (MTS) account, and/or an account (e.g., bank account, credit account, utility account, etc.) associated with a financial or business institution, such as a bank, credit union, store, utility, business, etc.) associated with the first user (and associated first communication device 102) or second user (and associated second communication device 104). The TMC 106 can comprise or be associated with an MTS 108, which is a service usable to transfer funds between communication devices. In an aspect, the TMC 106 can control the transfer of funds from the first communication device 102 to the second communication device 104 even if the second communication device 104 (and/or associated second user) is not registered with the TMC 106 and associated MTS 108.

In accordance with various other aspects, the TMC 106 can enable a user to manually or automatically transfer funds between the MTS service account and other third-party financial accounts of the user (e.g., associated with third-party institutions), and/or enable the user to transfers to other accounts, such as accounts associated with utility services, credit cards, or other types of service or product providers. In accordance with still other aspects, the TMC 106 can efficiently manage financial transactions (e.g., transfer of funds) between a registered MTS user and businesses (e.g., taxi drivers, brick-and-mortar businesses, online businesses, etc.) via, for example, pull payments facilitated using the first communication device 102, wherein the TMC 106 can manage and process the pull payments.

In accordance with various aspects and embodiments, the first communication device 102 can transfer funds using a web or mobile application (e.g., web application associated with the MTS 108 and provided by the transfer management component 106; or a mobile application associated with the MTS 108, provided by (e.g., downloaded to the first communication device 102 from) the TMC 106 (or a third-party vendor, such as a mobile phone service provider), and/or installed on the first communication device 102), a message application, such as, for example, a text message application (e.g., for sending and receiving text messages via a short message service (SMS)), instant message (IM) application, multimedia message application (e.g., for sending and receiving multimedia messages via a multimedia messaging service (MMS)), email message application, or voice mail message application, wherein a message application can be used to send or receive messages, including messages used to transfer funds from the first communication device 102 to the second communication device 104 via a communication network and as controlled by the transfer management component 106. The respective applications (e.g., web application, mobile application, message application) each can have respective application interfaces that can be presented and used on the first communication device 102. Similarly, the second communication device 104 can employ one or more of the respective applications, although the second communication device 104 is not required to have or access, for example, a web or mobile application associated with the MTS 108 in order to receive funds via the MTS 108.

In an aspect, to facilitate fund transfers via the MTS 108, the first user can use the first communication device 102 (or another communication device) to register the first user and/or first communication device 102 with the MTS 108 via the TMC 106, wherein the registration can be a regular registration for an unspecified amount of time or can be a one-time or temporary registration to facilitate a one-time fund transfer to the second user via, for example, the second communication device 104. As part of the registration process, the first user can provide information (e.g., name, address, financial account information, etc.) to the TMC 106 to facilitate registering at least one account (e.g., bank account, credit card account) of the first user with the MTS 108. The first user (e.g., via the first communication device 102) and/or the TMC 106 can provide (e.g., generate and present) authentication credentials (e.g., username, password, personal identification number (PIN), biometric information (e.g., fingerprint information, eye or iris related information, facial recognition related information, etc.) associated with the first user, communication device identifier (e.g., Media Access Control (MAC) address), etc.) Similarly, the second user (e.g., using the second communication device 104) can register with the MTS 108 via the TMC 106 to facilitate fund transfers via the MTS 108, although the second user is not required to register with the MTS 108 in order to receive funds via the MTS 108.

In accordance with an aspect, when the first user attempts to access the first user's service account 110 or the first user's user profile associated with the service account 110, the TMC 106 can control access to the first user's service account 110 and user profile. For instance, the TMC 106 can require the first user to provide authentication credentials via the first communication device 102 to the TMC 106 when the first user desires to access the service account 110 or user profile. The TMC 106 can analyze (e.g., compare) the authentication credentials received from the first communication device 102 to authentication credentials stored in or by the TMC 106. If the received authentication credentials match the stored authentication credentials, the TMC 106 can grant the first user (and associated first communication device 102) a subset of access rights, including the right to access and/or modify the service account 110 and associated user profile. If the received authentication credentials do not match the stored authentication credentials, the TMC 106 can deny the first user (and associated first communication device 102) access to the service account 110 and associated user profile and/or can prompt the first user to enter valid authentication credentials, for example, up to a predefined maximum number of failed authentication attempts, wherein, if the predefined maximum number of failed authentication attempts have occurred (e.g., consecutively), the first user and/or first communication device 102 can be locked out of the service account 110 and user profile until predefined conditions (e.g., a predefined amount of lock-out time passes, a reset has been performed, etc.) are met.

In another aspect, when the first user and/or associated first communication device 102 is registered with the TMC 106, a service account 110 (e.g., mobile service account, such as an MTS account) can be created, associated with the first user and/or associated first communication device 102, and stored by the TMC 106, wherein the service account 110 can be used by the first user to facilitate transferring funds to desired entities, such as, for example, the second user, a creditor, a financial institution, a utility company, and/or a store or other business, etc., any of which can, but is not required to be registered with the MTS 108 via the TMC 106.

As desired, the first user also can add one or more accounts (e.g., bank account, credit line account, etc.) to the first user's registration, and/or can select or provide a set of user preferences (e.g., select an account to be a default account from which to withdraw funds or to which to deposit funds; select a predefined minimum threshold fund level for the service account 110, wherein when the service account is below that level, money can be automatically deposited from another account of the first user; select a predefined maximum threshold fund level for the service account 110, wherein when the service account is above that level, money can be automatically deposited from the service account 110 into another account of the first user; UI display preferences; etc.), wherein information associated with the first user can be stored by the transfer management component 106 in a user profile of the first user.

In another aspect, the first communication device 102 can comprise a plurality of contacts, including information relating to those contacts, wherein the information can comprise respective names, phone numbers, email addresses, online site addresses (e.g., uniform resource locators (URLs)), etc., of the respective contacts. The first user can access a list of contacts on a user interface (UI) of the first communication device 102 and can select a desired contact from the list to facilitate fund transfers to the desired contact via an account associated with the desired contact and/or an associated communication device (e.g., second communication device 104).

As an example of doing a fund transfer using a web or mobile MTS application interface, the first user can use the first communication device 102 to access a web or mobile application (e.g., web or mobile MTS application) and, in response, a web or mobile application interface can be presented on a UI (e.g., graphical UI (GUI) or touch screen GUI) of the first communication device 102 to the first user. The UI can include one or more UI controls or buttons, such as a control to send funds to another user (e.g., contact on a contact list), wherein such control can be labeled as desired (e.g., a “send money” control or “transfer money to contact” control). The UI controls also can comprise a “call” control to initiate a phone call to the specified user or a “message” control to send a message (e.g., instant message (IM), text message, email message, etc.) to the specified user. All or a portion of the UI controls can be presented along with the contact list or upon selection of a contact from the contact list or entering information relating to a user not currently on the contact list.

To send funds to the second user, the first user can use the application interface on the first communication device 102 to select the second user (e.g., intended recipient of the transferred funds) from a contact list or enter information, such as address information (e.g., phone number, email address, etc.), for the second user via the application interface. The application interface can present a field (e.g., a pop-up field) to the first user to enter a fund amount to transfer or a predefined set of typical fund amounts (e.g., $20, $50, $100, . . . ) wherein the first user can interact (e.g., touch, gesture, select a button) with the application interface to select the desired fund amount from the set, and/or can present a menu (e.g., tool bar, pop-up menu, etc.) with available options, controls, buttons, etc., which can include a set of registered accounts (e.g., service account 110, bank account, credit line account) from which the funds to be transferred can be withdrawn and the first user can select a desired account from which to withdraw the funds for the transfer.

The first user also has the option of using the application interface to generate and send a message (e.g., a personal message, such as “Hi [second user], here is the money I promised you.”) with the MTS fund transfer. Once the first user has completed the request for the MTS fund transfer, the first user can use the application interface to submit (e.g., transmit) the request to the transfer management component 106 for processing.

The TMC 106 can receive the request for the MTS fund transfer from the first communication device 102. If the first communication device 102 is not yet authenticated by the TMC 106, the TMC 106 can request that authentication credentials be provided by the first communication device 102, and the TMC 106 can authenticate the first communication device 102 (and associated first user), as more fully disclosed herein. The TMC 106 can analyze the information in the request for MTS fund transfer, the user profile of the sender, and the user profile of the intended recipient, to identify the sender (e.g., first user), the intended recipient (e.g., second user), the destination address (e.g., phone number, email, etc.) associated with the intended recipient, the amount of the fund transfer, the account (e.g., service account 110) from which the funds are to be withdrawn, the account (e.g., service account) of the second user to which the funds are to be transferred, user preferences of the first user, user preferences of the second user, message content in the request, etc. Based at least in part on the results of the analysis, the TMC 106 can process the request and can withdraw the funds from the account of the first user (e.g., as specified in the request or in accordance with the first user's user preferences); deposit the funds into the account associated with the second user (e.g., in accordance with the second user's user preferences); update the account information of the respective accounts; generate a message or notification regarding the MTS fund transfer, wherein the message or notification (e.g., MTS message or notification) can include information regarding the amount of funds transferred to the second user, the account of the second user in which the funds have been deposited, an update balance of the second user's account balance, and/or a message from the first user, etc.; and transfer the message or notification to the second communication device 104.

The second communication device 104 can receive the message or notification (e.g., MTS message or notification) from the TMC 106. In an aspect, the second communication device 104 also can access or comprise a web or mobile MTS application and can present a web or mobile application interface to the second user. The received message or notification can be presented (e.g., displayed) to the second user via the application interface, and the second user can view the information (e.g., amount of funds transferred, account into which the funds were transferred, secure token that can be used to immediately utilize the transferred funds, information identifying the sender of the funds, personal message from the sender, etc.) contained in the message or notification. At a desired time (e.g., immediately or at a future time), the second user can use the second communication device 104 (or another associated communication device) to retrieve all or a portion of the transferred funds, utilize (e.g., spend) all or a portion of the transferred funds (e.g., using a secure token relating to the transferred funds), transfer the transferred funds to a different account of the second user, etc.

In an aspect, funds can be transferred from the first user to the second user using the MTS even if the second user is not registered with the TMC 106. For example, the first user can use either the web or mobile application interface on the first communication device 102 to request to transfer funds to the second user via an MTS message or notification, or can use a message interface (e.g., text, IM or email interface) on the first communication device 102 to generate and send a message comprising an authorization for a funds transfer, notification of the funds transfer, an “accept money” link (e.g., URL) and/or the transferred funds (e.g., in the form of a secure token that contains the transferred funds) to facilitate transferring funds to the second user via a text message, an IM, an email, etc.

When the fund transfer is being done via an MTS fund transfer request from the first communication device 102, the TMC 106 can receive the fund transfer request and can process the request to transfer funds to the second user, even if the second user is not registered with the TMC 106. In such instance, the TMC 106 can place a hold on the service account 110 (or other specified account) in the amount of the fund transfer, allocate or partition the amount of the fund transfer but continue to have those funds remain in the service account 110 (or other specified account), or remove the funds being transferred from the service account 110 (or other specified account) and store the transferred funds in a temporary service account that can be associated with the second user, even though the second user is not registered with the TMC 106.

The TMC 106 also can generate and transmit a message (e.g., text message, multimedia message, email, voice mail, etc.), comprising information relating to the transferred funds or the funds (e.g., in the form of a secure token), wherein the message can be transmitted to the second communication device 104. The message can comprise information relating to the transferred funds can comprise a link (e.g., “accept money” link) that can be selected using the message interface on the second communication device 104 to connect the second communication device 104 to the TMC 106 to obtain (e.g., automatically withdraw) the transferred funds, a secure token that can enable the second user to immediately use the transferred funds or use those funds at another desired time and/or information that can instruct the second user how to obtain the transferred funds from a physical (e.g., geographical) address, information deposit the transferred funds into an account associated with the second user, information requesting, instructing and/or enabling the second user to register with the TMC 106 to facilitate depositing the funds into a regular service account or another registered account of the second user, a personal message from the first user, and/or other information.

The second communication device 104 can receive the fund transfer message from the TMC 106. The second user can view the message in the message application interface of the second communication device 104. In response to the message, the second user can use the second communication device 104 to select the link (e.g., “accept money” link), which can connect the user to an online site associated with the TMC 106, to obtain the transferred funds or move the funds to a desired account (e.g., by providing the TMC 106 information regarding the account to which the funds are to be moved); use the secure token to make a purchase (e.g., at a physical or online store), pay a bill (e.g., utility bill, credit card bill, etc.), deposit the funds associated with the secure token into a desired account, or present the secure token to the TMC 106 for redemption (e.g., if the secure token itself does not comprise or represent the transferred funds), etc.; view the physical address displayed in the message and travel to that physical address to pick up the funds; register the second user, second communication device 104, and/or an account of the second user with the TMC 106; etc.

In instances where the first communication device 102 is used to send a message (e.g., text, IM or email message) relating to the fund transfer to the second communication device 104, the message can include, for example, a link (e.g., “accept money” link) that can be selected using the message interface on the second communication device 104 to obtain the transferred funds, a personal message from the first user, and/or other information. The second user can use the second communication device 104 to select the link, which can connect the user to an online site associated with the TMC 106, to enable the second user to obtain (e.g., automatically withdraw) the transferred funds, obtain a secure token comprising the transferred funds, or otherwise process the funds (e.g., have funds deposited into a desired account of the second user, use funds to pay a bill, etc.), obtain information that can instruct the second user how to obtain the transferred funds from a physical (e.g., geographical) address, register the second user, second communication device and/or an account of the second user with the TMC 106, and/or take other action.

In accordance with various aspects, when the second user is not registered with the TMC 106, and receives a fund transfer message from the TMC 106 or first communication device 102, the second user (and associated second communication device 104) is not necessarily required to be authenticated by the TMC 106 in the same manner as the first user, although, as desired, authentication procedures can be employed to authenticate the second user (and associated second communication device 104), if desired. For example, when the second communication device 104 receives the fund transfer message, the second user can select the “accept money” link in the message, which can result in an online page associated with the TMC 106 opening up on an interface (e.g., web browser window) on the second communication device 104. The online page can request that the second user and/or associated second communication device 104 be authenticated before transferring the funds to the second user. For instance, the online page can request that the second user enter the phone number of the second communication device 104 (or email address associated with the second user) in the phone number field (or email field) on the online page, and further request that the second user press a “get code” button or control on the online page, wherein selection of the “get code” button can or control can result in a authentication code being sent to the second communication device 104 by the TMC 106. The online page can further request that the second user enter the received code into a code field on the online page, and press an “enter” control on the online page to submit the code to the TMC 106 for verification by the TMC 106. If the code matches the code the TMC 106 sent to the second communication device, the TMC 106 can deem the second user and second communication device 104 authenticated, and can allow the second user to access and manage the transferred funds. If the code does not match the code the TMC 106 sent to the second communication device, the TMC 106 can deem the second user and second communication device 104 as not being authenticated, and can deny the second user access to the transferred funds.

As another example, the first user can include a challenge (e.g., question) as part of the fund transfer request (e.g., whether in an MTS request or a message (e.g., text, IM or email message) to the second user), which can require a valid response (e.g., valid answer to the question in the challenge) from the second user in order for the second user to be able to obtain the transferred funds via the TMC 106. In such instance, the TMC 106 can allow the second user to obtain the transferred funds if a valid response is provided in response to the challenge, or the TMC 106 can deny the transferred funds if the response from the second user (e.g., via the second communication device 104) is not valid, wherein the TMC 106 can allow the second user to provide a valid response up to a predefined number of attempts to provide a valid response. If a valid response is not received within the predefined number of attempts, the TMC 106 can deny the second communication device 104 (and associated second user) access to the transferred funds and/or can transmit a message to the first communication device 102 (and/or associated first user) and the second communication device 104 (and/or associated second user) notifying the first and/or second user of the failure to complete the fund transfer, in accordance with predefined transfer criteria. The first and/or second users can take further action to attempt to complete the fund transfer, as desired (e.g., first user can re-submit or re-authorize the fund transfer to the second user).

As another example, the fund transfer request or fund transfer message from the first user can comprise a digital image (e.g., digital picture) of or associated with the second user (or first user) or other information (e.g., authentication information, such as a fund transfer retrieval code) that can be used to facilitate authenticating the second user with regard to a fund transfer, wherein the digital image can comprise physical features of the second user (or first user) or another digital image that can be known to the second user, and the second user can provide a same or representative digital image (e.g., image comprising the second user's face) (or corresponding code) to that provided as part of the fund transfer request to the TMC 106, and the TMC 106 can compare the image provided as part of the fund transfer request (or other provided authentication information) to the image (or other authentication information) provided by the second communication device 104 of the second user, and the TMC 106 can authenticate the second user if the authentication information provided by the second user matches, or at least substantially matches, the authentication information associated with the fund transfer request or fund transfer message, or the TMC 106 can determine that the second user is not authenticated if the authentication information provided by the second user does not match, or does not at least substantially match, the authentication information associated with the fund transfer request or fund transfer message.

As disclosed herein, a fund transfer message (e.g., in the form of an MTS message, a text message, an IM, an email message, a multimedia message, etc.) can comprise a token, such as a secure token. A secure token can comprise the transferred funds (e.g., in an electronic form, as an electronic structure, as an electronic object) and/or information relating to the transferred funds to facilitate obtaining and/or using of the transferred funds by the intended recipient. For example, the secure token can be an electronic form of money or a mobile temporary financial account comprising a specified amount of funds (e.g., the transferred funds). In an aspect, a secure token can be a one-time secure token that can only be used for a single withdrawal of purchase, or a limited-use secure token that can be used a multiple number of times until the funds associated with the secure token have been exhausted, until the secure token has been accessed a specified number of times, or until a predefined amount of time has expired.

In accordance with another aspect, the secure token can be secured by locking the secure token and/or encrypting information and/or the funds in the secure token, in accordance with predefined security protocols (e.g., cryptographic protocols or algorithms). For example, a secure token can be locked and/or encrypted wherein a code, key, or authentication information (e.g., authentication credentials), etc., can be utilized with a cryptographic protocol or algorithm to lock the secure token and/or encrypt the information and/or funds contained in the secure token. For instance, the code, key, or authentication information, and/or a random or pseudo-random number (e.g., from a random number generator employed by the TMC 106 or a mobile TMC of a communication device (e.g., 102, 104)) can be used to lock the secure token such that the secure token cannot be unlocked and the information and/or funds therein presented to a user via a communication device unless the code, key, or authentication information, and/or the random or pseudo-random number, is presented to the secure token (e.g., input to an interface associated with the secure token and presented to the communication device) via the communication device. Additionally or alternatively, the code, key, or authentication information, and/or a random or pseudo-random number can be used to encrypt data (e.g., information, funds) contained in the secure token such that the data contained in the secure token cannot be decrypted and the information and/or funds therein presented in decrypted form to a user via a communication device unless the code, key, or authentication information, and/or the random or pseudo-random number, is presented to the secure token (e.g., input to an interface associated with the secure token and presented to the communication device) via the communication device. As an example, if an intended recipient receives a secure token that is contained on the communication device (e.g., 104) of the intended recipient, and the intended recipient attempts to access the secure token, for instance, by selecting the secure token via a UI of the communication device, the secure token can present a UI (e.g., secure token UI) on the communication device and can request the intended recipient to input information, such as the code, key, authentication information, etc. (e.g., phone number, authorization or validation code or password known to the intended recipient, response (e.g., answer) to a challenge (e.g., question), etc.), wherein the input information, if valid, can unlock the secure token and/or decrypt the data therein, or, access to the secure token can be denied or unusable information can be presented if the input information is not valid.

In an aspect, the intended recipient, using the communication device (e.g., 104), can present the secure token, as unlocked and/or decrypted, to another communication device associated with an entity (e.g., a store, a utility, a credit provider, a financial institution, a friend, etc.) to use or transfer the funds contained in the secure token. Alternatively, the intended recipient, using the communication device (e.g., 104), can present the secure token, still secured, to another communication device associated with an entity to use or transfer the funds contained in the secure token, wherein the intended recipient or associated communication device can provide the input information that can be used to unlock and/or decrypt the secure token.

In another aspect, to transfer all or a portion of the funds contained in a secure token, the intended recipient's communication device can transmit the secure token (or a portion of the funds in the secure token) to the other communication device of the entity via a direct (e.g., wireless) communication channel or via a communication network, as more fully described herein. As a result, the secure token can be immediately used as money without further involvement of the TMC 106.

Additionally or alternatively, a secure token can include information relating to the transferred funds, but not the funds themselves. The secure token can be unlocked and/or the information contained in the secure token can be decrypted, as described herein. To provide the information relating to the funds contained in the secure token, the intended recipient's communication device can transmit the secure token to the other communication device of the entity via a direct (e.g., wireless) communication channel or via a communication network, as more fully described herein, or the secure token can comprise or be associated with a bar code or other machine-readable code (e.g., computer readable code) that can be presented, via an interface on the intended recipient's communication device, wherein the machine-readable code can be scanned or read by the other communication device of the entity, and wherein the information contained in the machine-readable code can provide the other communication device with information relating to the funds associated with the secure token. The other communication device of the entity can present the information relating to the secure token to the TMC 106, and/or other information (e.g., code, key, authentication information, etc., if necessary) to facilitate obtaining the funds associated with the secure token, and the TMC 106 can provide the funds to the other communication device or to an account associated with the entity.

In yet another aspect, the first communication device 102 can generate a secure token (e.g., via a mobile TMC, as more fully disclosed herein) with or without the initial involvement of the TMC 106. For instance, the first communication device 102 can use the web or mobile MTS application to generate a secure token comprising the transferred funds or information relating thereto. The first communication device 102 optionally can notify the TMC 106 about the secure token or provide a copy of the secure token to the TMC 106, but is not required to do so. The first communication device 102 can generate and transmit a message, comprising the secure token, to the second communication device 104 via a direct communication channel or via the communication network, as more fully described herein. If the funds are contained in the secure token, the intended recipient associated with the second communication device 104 can retrieve the funds from the secure token, as described herein, without having to contact the TMC 106, unless the secure token is structured to require such contact. Such use of a secure token and transmission via a traditional type of communication (e.g., email, IM, text message, etc.) received from a known sender can be useful, as the intended recipient can have a desired level of trust in relation to such a message from the sender, while the intended recipient may not have as high of a level of trust with a message (e.g., MTS message) received from a third-party communication device (e.g., TMC 106) or entity. In another aspect, as desired, the secure token can be structured such that the intended recipient, using the second communication device 104, can be required to present the secured token or information (e.g., code or other authentication or authorization information) relating thereto to the TMC 106 in order to use and/or obtain the transferred funds.

In accordance with various other aspects and embodiments, the first communication device 102 and second communication device 104 can employ near field communication (NFC) and/or other wireless communication technology(ies) (e.g., Bluetooth) to enable the first communication device 102 and second communication device 104 to communicate directly with each other, or employ other communication technology (e.g., mobile core network, Wi-Fi network, IP-based network, etc.) to communicate with each other, to facilitate a fund transfer between the first communication device 102 and second communication device 104, wherein the fund transfer can be processed via the TMC 106. In such instance, the first communication device 102 and second communication device 104 can be mutually authenticated with each other and/or the respective first and second users can use their respective communication devices 102 and 104 to agree to allow the respective communication devices 102 and 104 to communicate with each other.

In an aspect, once the first communication device 102 and second communication device 104 are mutually authenticated or are otherwise permitted to communicate with each other with regard to a fund transfer, the first communication device 102 and second communication device 104 can communicate with each other to exchange information relating to the fund transfer. For example, the first communication device 102 can obtain information (e.g., phone number, email address, account information, etc.) regarding the second communication device 104 (or second user) in order to generate a request for a fund transfer to the second user and/or the second communication device 104 can obtain information (e.g., identification information, account information, secure token, etc.) to facilitate the fund transfer from the first communication device 102.

For example, the first communication device 102 (e.g., using a web or mobile MTS application and/or associated application interface) can be employed to generate a secure token associated with (e.g., comprising or representing a specified amount of funds being transferred from the first user to the second user) and transmit the secure token directly from the first communication device 102 to the second communication device 104 via a direct communication connection (or via a communication network, such as a mobile core network, a Wi-Fi network, an IP-based network, etc.) between the first communication device 102 to the second communication device 104, wherein the second user can use the second communication device 104 to communicate with the TMC 106 to redeem or exchange the secure token to obtain the transferred funds associated with the secure token (e.g., single-use secure token or limited-use secure token) or otherwise use the transferred funds, and/or can transfer all or a portion of the transferred funds to a third user and/or associated third communication device (not shown in FIG. 1). In this example, the TMC 106 is not required to create a temporary service account for the second user (although the TMC 106 can create such a temporary service account for the second user) as the TMC 106 can process the secure token to withdraw the funds associated with the token from the service account 110 or other associated account of the first user and can provide the transferred funds to the second user, as specified by the second user (e.g., via information provided using the second communication device 104).

In an embodiment, direct communication or indirect communication (e.g., via the communication network without communicating the fund transfer via the TMC 106, or via the communication network by communicating the fund transfer via the TMC 106) of a fund transfer from the first user via the first communication device 102 to the second user via the second communication device 104 can be facilitated using a “bump” or “touch” feature that can be part of the web or mobile application or can be a separate application, wherein the communication relating to the fund transfer can be performed or facilitated by the first communication device 102 and second communication device 104 coming into contact with each other or within close proximity of each other (e.g., within a predefined distance of each other).

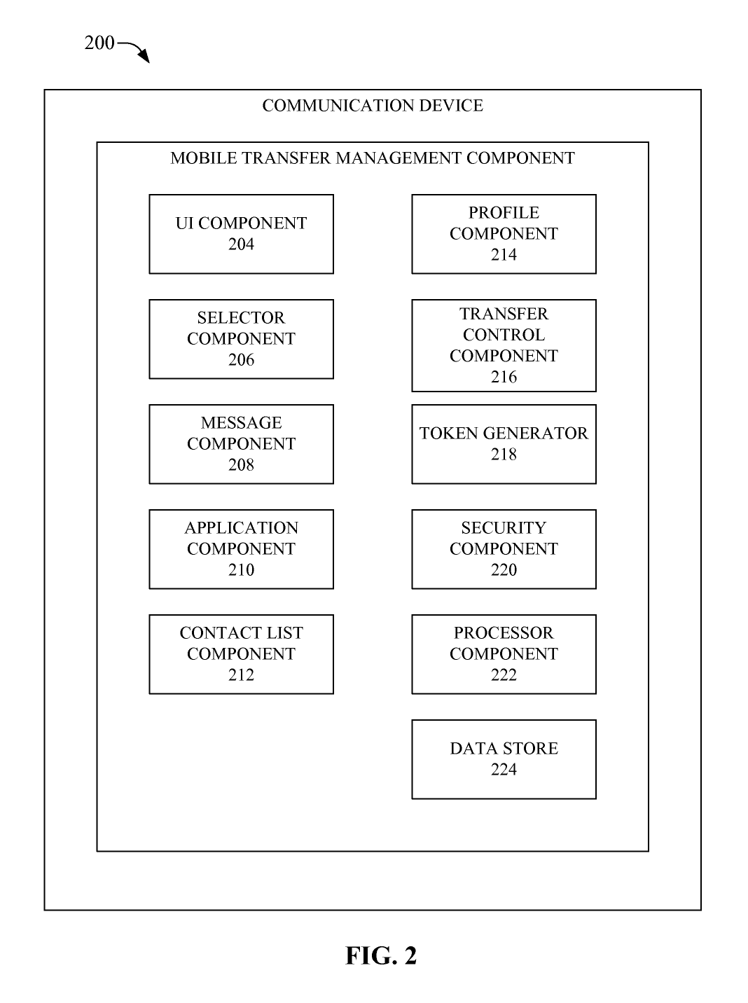

FIG. 2 depicts a block diagram of an example communication device 200 in accordance with various aspects and embodiments of the disclosed subject matter. In an aspect, the communication device 200 can comprise a mobile TMC 202 that can be employed to facilitate fund transfers between the communication device 200 and other communication devices in a communication network environment. The TMC 202 can comprise a UI component 204 that can provide one or more GUIs (e.g., message interface, MTS mobile application interface, etc.), command line interfaces, and the like. For example, a GUI (e.g., touch screen GUI) can be rendered that provides a user with a region or means to load, import, read, etc., data, and can include a region to present the results of such. These regions can comprise known text and/or graphic regions comprising dialogue boxes, controls (e.g., static controls), drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. In still another aspect, the UI component 204 can receive and/or respond to a swipe gesture(s) (e.g., via a touch screen GUI), wherein a desired action (e.g., unlocking of the communication device or associated display or keys, scrolling through a menu, moving from one area of a displayed item, such as a screen, to another area of that item, adjusting the size of a displayed item, etc.). For instance, a displayed menu or screen can be sized such that it is larger than the display screen of the UI component 204. The UI component 204 can receive a particular swipe gesture via the touch screen GUI, and in response, the menu can be scrolled to display different menu items, including items that were previously outside of the display area, or a different portion of the screen can be displayed, such as a region of the screen that was previously not viewable on the display prior to the swipe gesture. Alternatively or additionally, a mouse can be used to click and drag on the screen to move the screen in the display so that the desired portion of the screen is displayed on the display; or one or more buttons (e.g., ctrl button+an arrowed or directional button) on a keyboard can be manipulated to move the screen in the display so that the desired portion of the screen is displayed on the display. In an aspect, the user can interact with one or more of the components coupled to and/or incorporated into a processor(s) (e.g., host processor).

The user can also interact with the regions to select and provide information via various devices such as a mouse, a roller ball, a keypad, a track pad, a keyboard, a pen and/or voice activation, for example. Typically, a mechanism such as a push button or the enter key on the keyboard can be employed subsequent entering the information in order to initiate the search. However, it is to be appreciated that the disclosed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

Further, the UI component 204 can include or can be associated with a scanner that can receive data (e.g., authentication credentials, user data, etc.) from other components (e.g., host processor) associated with the mobile TMC 202. The scanner can be a type whereby a device (e.g., smart card) containing the data can be swiped through the scanner, which can read data associated with the device and/or the scanner can be a wireless scanner (e.g., RFID-type scanner) that can receive or read data associated with a device that contains the data when the device is within a predefined area near the wireless scanner such that the wireless scanner is able to communicate with the device to read or receive the data from the device.

In another aspect, the mobile TMC 202 can include a selector component 206 that can enable a user to select buttons, controls, links, files, folders, or other items, presented by or available via the UI component 204. In response to selection of an item, a corresponding action can be performed, wherein, depending in part on the item selected, the action can comprise, selecting a contact from a contact list, entering information (e.g., information regarding the fund amount) via the mobile TMC 202, selecting or opening a file or file folder, selecting a control (e.g., “transfer money” control), selecting a fund amount, selecting a link (e.g., “accept money” link), selecting a menu, selecting a message control to open a message application, etc.

In still another aspect, the mobile TMC 202 can contain a message component 208 that can be employed to generate, receive, or display MTS messages or requests, or other messages, such as text messages, IMs, multimedia messages, email messages, voice mail messages, notifications, etc. The message component 208, in conjunction with the UI component 204, can provide respective message interfaces in relation to the respective types of messages.

In yet another aspect, the mobile TMC 202 can include an application component 210 that can comprise one or more applications, including, for example, an MTS mobile application, a web browser application, a message application, a call application, a contact list application, a financial account application, and/or other desired applications, which can be pre-installed or downloaded onto the communication device associated with the mobile TMC 202 at a desired time. Respective applications can provide respective application interfaces that can be provided to the user via the UI component 204.

In an aspect, the mobile TMC 202 can comprise a contact list component 212 that can present a contact list of persons or entities who can be selected by the user, for example, to make a phone call, send a message, transfer money, etc. The user can utilize the selector component 206 to select a desired user from the contact list. The UI component 204 can be used to facilitate modifying the contact to add, remove, or change information (e.g., name, phone number, geographical address, email address, etc.) relating to a person or entity.

In another aspect, the mobile TMC 202 can comprise a profile component 214 that that can be employed to generate and maintain a user profile of the user, wherein the user profile can include information relating to the user, user preferences of the user, for example, in relation to fund transfers, account information regarding one or more accounts of the user, etc. The user, using the UI component 204 and profile component 214, can create or modify the user profile, as desired.

In still another aspect, the mobile TMC 202 can contain a transfer control component 216 that can be employed to control generation of fund transfers that are to be sent to other communication devices and associated users and processing of fund transfers received from other communication devices, including the TMC (e.g., 106), manage the user profile and account information associated with the user of the communication device 200, and perform other management functions relating to fund transfers.

In yet another aspect, the mobile TMC 202 can include a token generator 218 that, when desired, can be employed to generate a token, such as a secure token, that can comprise or be associated with a specified amount of monetary funds, wherein the token can be included in a fund transfer request or message to send funds to another communication device associated with the intended recipient. For example, monetary funds can be embedded or represented in an electronic form (e.g., data) in the secure token, wherein the secure token can be presented and used like physical money (e.g., paper money). A secured token can be secured using authentication protocols and cryptographic protocols to ensure that the secure token, and/or the embedded funds (when funds are embedded in the secure token), is only able to be accessed by an authorized entity (e.g., intended recipient, TMC).

In accordance with various aspects, the mobile TMC 202 can contain a security component 220 that can provide security with regard to fund transfers and messages. The security component 220 can employ authentication protocols and cryptographic protocols (e.g., protocol relating to data encryption and decryption, public key cryptography, symmetric key, Public key infrastructure (PKI), Digital Signature Standard (DSS), Data Encryption Standard (DES), triple-DES, Advanced Encryption Standard (AES), cryptographic hash functions, etc.) to facilitate securing fund transfer requests or messages, communications between the communication device 200 and the TMC (e.g., 106) or another communication device, securing secure tokens and information or funds contained therein, etc. The security component 220 can use a desired cryptographic protocol to encrypt voice or data for transmission and decrypt voice or data when received. The security component 220 can employ a desired authentication protocol(s) to control access to the web or mobile MTS application, the user profile, a secure token, etc., to restrict access to an authorized entity (e.g., intended recipient, TMC), as more fully described herein.

In an aspect, the mobile TMC 202 can comprise a processor component 222 that can work in conjunction with the other components (e.g., UI component 204, selector component 206, message component 208, etc.) to facilitate performing the various functions of the mobile TMC 202. The processor component 222 can employ one or more processors, microprocessors, or controllers that can process data, such as information relating to generating, sending, receiving or processing fund transfers, information relating to tokens, information relating to cryptography or authentication, information relating to other operations of the mobile TMC 202, and/or other information, etc., to facilitate operation of the mobile TMC 202, as more fully disclosed herein, and control data flow between the mobile TMC 202 and other components (e.g., other components of the communication device 200, TMC (e.g., 106), other communication device (e.g., 104), etc.) associated with the mobile TMC 202.

The mobile TMC 202 also can include a data store 224 that can store data structures (e.g., user data, metadata), code structure(s) (e.g., modules, objects, hashes, classes, procedures) or instructions, information relating to generating, sending, receiving or processing fund transfers, information relating to tokens, information relating to cryptography or authentication, information relating to other operations of the mobile TMC 202, and/or other information, etc., to facilitate controlling operations associated with the mobile TMC 202. In an aspect, the processor component 222 can be functionally coupled (e.g., through a memory bus) to the data store 224 in order to store and retrieve information desired to operate and/or confer functionality, at least in part, to the UI component 204, selector component 206, message component 208, etc., and/or substantially any other operational aspects of the mobile TMC 202.

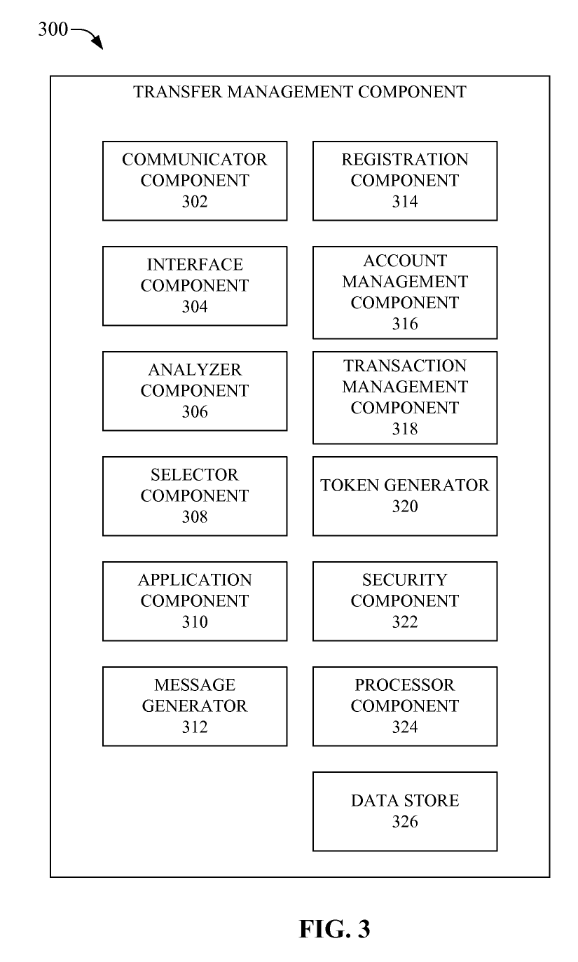

FIG. 3 depicts a block diagram of an example TMC 300 in accordance with various aspects and embodiments of the disclosed subject matter. In an aspect, the TMC 300 can comprise a communicator component 302 that can be employed to communicate (e.g., transmit, receive) information, including information relating to fund transfers, between the TMC 300 and other components or devices, such as communication devices associated with a communication network environment. The communicator component 302 can employ one or more communication protocols to facilitate controlling data or voice flows associated with the TMC 300.

In another aspect, the TMC 300 can include an interface component 304 that can comprise one or more interfaces, including one or more controls, switches, adapters, connectors, buttons, routers, speakers, display screens, GUIs, and/or touch screen GUIs, etc., that can facilitate enabling the TMC 300 to interface and/or communicate with other systems or components, such as communication devices and/or a communication network(s). For instance, the interface component 304 can comprise all or a portion of the components, features, or functionality, as described with regard to UI component 204 in FIG. 2, as disclosed herein.

In still another aspect, the TMC 300 can include an analyzer component 306 that can analyze or parse information, including information relating to fund transfers, registration of users, log in or authentication of users, account information, user profiles, etc., to identify or determine information contained in a fund transfer request, whether a user or associated communication device is registered with the TMC 300, whether a user is authenticated, a subset of access rights to grant to an authenticated user, an account to use during a fund transfer, whether to transfer funds from one account to another, whether to authorize a withdrawal of funds from an account, what information to include in a message or notification relating to a fund transfer, etc.

In another aspect, the TMC 300 can include a selector component 308 that can be employed to select information, an account, an amount of funds, a type of message to generate, a user profile, authentication credentials, etc., in relation to a fund transfer, a registration of a user or an account, or other event relating to the MTS. For example, the selector component 308 can select an account from which to withdraw funds with regard to a particular fund transfer based at least in part on user preferences and/or amount of available funds in the account. As another example, the selector component 308 can select a type of message to generate in relation to fund transfer based at least in part on user preferences relating to the fund transfer, whether the intended recipient is registered with the TMC 300, and/or other factors.

In yet another aspect, the TMC 300 can contain an application component 310 that can comprise one or more applications, including an MTS web application that can be made available to a user via a communication device to facilitate fund transfers, a user MTS mobile application that can be provided to a communication device of a user to provide additional functionality to the communication device relating to fund transfers with the TMC 300 to facilitate fund transfers with the TMC 300, an MTS mobile application that can be utilized by the TMC 300 in conjunction with the user MTS mobile application to facilitate fund transfers, a messaging application that can be employed by the TMC 300 to generate, transmit or receive messages of various types (e.g., text message, email message, MTS message, IM, multimedia message, voice mail message, etc.) in relation to the MTS, a financial transaction application that can facilitate performing functions relating to financial transactions, an authentication application to facilitate authenticating users, a cryptographic application to facilitate performing cryptographic functions, a registration application to facilitate registration of users to use the MTS and register associated accounts of the users, etc. In another aspect, the TMC 300 can include a message generator 312, which can operate in conjunction with one or more messaging applications, to generate, transmit or receive messages, including facilitating inputting information into messages.

In yet another aspect, the TMC 300 can contain a registration component 314 that can be employed to register users and register accounts associated with users to facilitate enabling the users to use the MTS. In another aspect, the TMC 300 can employ an account management component 316 that can operate in conjunction with the registration component 314 and transaction management component 318, to facilitate registering an account of a user, modifying information relating to an account of a user, managing a service account (e.g., MTS account) of a user, managing interaction (e.g., withdrawals, deposits) with other accounts (e.g., bank accounts, credit card accounts, utility accounts, etc.) associated with the user, etc.

In an aspect, the TMC 300 can include the transaction management component 318, which can operate in conjunction with the other components of the TMC 300 to control fund transfers between communication devices, control withdrawals from or deposits to an account associated with a user in relation to a fund transfer, control access to an account of a user, control the generation of a message or notification relating to a fund transfer, control processing of a fund transfer request, control processing of a transfer of funds in response to receiving an indication that an intended recipient is accepting the fund transfer, control the generation of a token, etc.

In yet another aspect, the TMC 300 can include a token generator 320 that, when desired, can be employed to generate a token, such as a secure token, that can comprise or be associated with a specified amount of monetary funds, wherein the token can be included in a message to send funds to another communication device associated with the intended recipient as part of a transfer fund request. For example, monetary funds can be embedded or represented in an electronic form (e.g., data) in a secure token, wherein the secure token can be presented and used like physical money (e.g., paper money) by the intended recipient when received by the communication device of the intended recipient. In an aspect, a secured token can be secured using authentication protocols and cryptographic protocols to ensure that the secure token, and/or the embedded funds (when funds are embedded in the secure token), is only able to be accessed by an authorized entity (e.g., intended recipient, TMC).

In accordance with various aspects, the TMC 300 can contain a security component 322 that can secure information relating to fund transfers and messages. The security component 322 can employ authentication protocols and cryptographic protocols (e.g., protocol relating to data encryption and decryption, public key cryptography, symmetric key, Public key infrastructure (PKI), Digital Signature Standard (DSS), Data Encryption Standard (DES), triple-DES, Advanced Encryption Standard (AES), cryptographic hash functions, etc.) to facilitate securing messages relating to fund transfers, communications between the TMC 300 and a communication device (e.g., communication device transferring funds, communication device receiving funds, communication device associated with a third-party account, etc.), securing information relating to secure tokens, etc. The security component 322 can use a desired cryptographic protocol to encrypt voice or data for transmission and decrypt voice or data when received. The security component 322 can employ a desired authentication protocol(s) to control access to an account associated with a user, a user profile, a fund transfer, a secure token, etc., to restrict access to an authorized entity (e.g., intended recipient, payee), as more fully described herein.

In yet another aspect, the TMC 300 can comprise a processor component 324 that can work in conjunction with the other components (e.g., communicator component 302, interface component 304, analyzer component 306, etc.) to facilitate performing the various functions of the TMC 300. The processor component 324 can employ one or more processors, microprocessors, or controllers that can process data, such as information relating to fund transfers, user profiles, user preferences, accounts associated with users, authentication, encryption or decryption, tokens, operations of the TMC 300, and/or other information, etc., to facilitate operation of the TMC 300, as more fully disclosed herein, and control data flow between the TMC 300 and other components (e.g., communication device, communication network, etc.) associated with the TMC 300.

The TMC 300 also can include a data store 326 that can store data structures (e.g., user data, metadata), code structure(s) (e.g., modules, objects, hashes, classes, procedures) or instructions, information relating to fund transfers, user profiles, user preferences, accounts associated with users, authentication, encryption or decryption, tokens, operations of the TMC 300, and/or other information, etc., to facilitate controlling operations associated with the TMC 300. In an aspect, the processor component 324 can be functionally coupled (e.g., through a memory bus) to the data store 326 in order to store and retrieve information desired to operate and/or confer functionality, at least in part, to the communicator component 302, interface component 304, analyzer component 306, etc., and/or substantially any other operational aspects of the TMC 300.

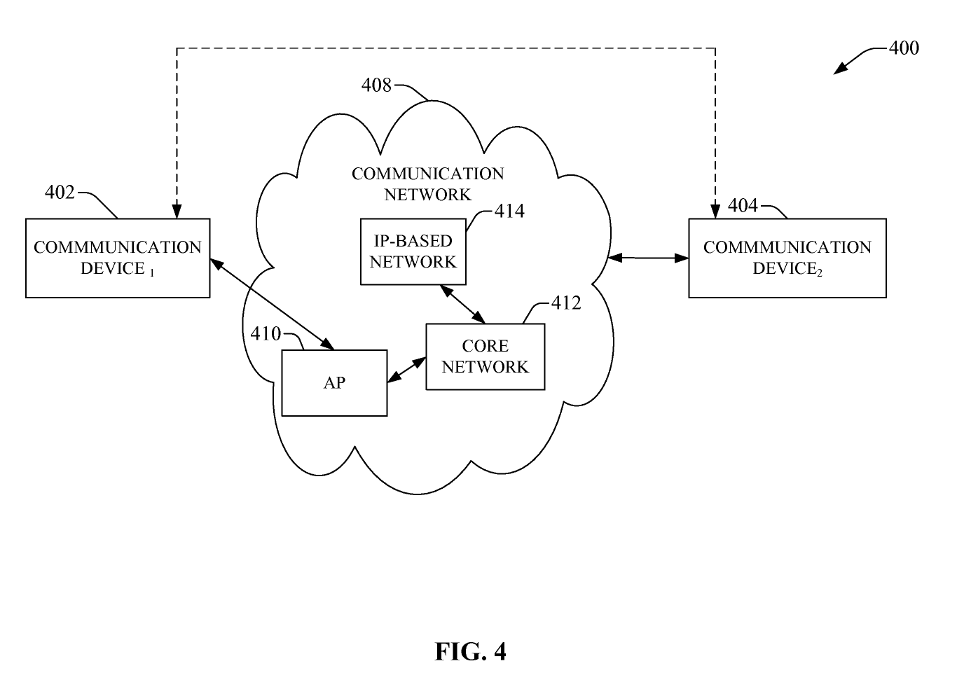

FIG. 4 illustrates a diagram of an example system 400 that can facilitate money transfers in accordance with various aspects and embodiments of the disclosed subject matter. In an aspect, the system 400 can include a plurality of communication devices, including a first communication device 402 (also referred to as communication device₁) and a second communication device 404 (also referred to as communication device₂) that can communicate (e.g., voice, data) with each other or other communication devices (e.g., TMC) associated with the system 400. The system 400 can include a TMC 406 that can be associated with an MTS (not shown in FIG. 4) and can control fund transfers between communication devices and associated communication device users, as more fully described herein.

In another aspect, the system 400 can comprise a communication network 408 that can be employed to facilitate communication of voice and data between the first communication device 402, second communication device 404, TMC 406, or other communication devices associated with the communication network 408. Each of the communication devices can connect to the communication network 408 via a wireline or wireless communication connection. The communication network 408 can comprise or be associated with a number of access points (APs) (e.g., base station), including AP 410, wherein the AP 410 can facilitate wireless connection of a communication device (e.g., 402) with the communication network 408, when a wireless connection is desired.

In accordance with various aspects, as a communication device (e.g., 402) is moved through a wireless communication network environment, at various times, the communication device can be connected (e.g., wirelessly connected) to one of a plurality of APs (e.g., macro or cellular AP, femto AP, pico AP, Wi-Fi AP, Wi-Max AP, etc.), such as the AP 410, that can operate in the wireless communication network environment. An AP (e.g., 410) can serve a specified coverage area to facilitate communication by the communication device or other communication devices in the wireless communication network environment. The AP can serve a respective coverage cell (e.g., macrocell, femtocell, picocell, etc.) that can cover a respective specified area, and the AP can service mobile wireless devices (e.g., communication device 402) located in the respective area covered by the respective cell, where such coverage can be achieved via a wireless link (e.g., uplink (UL), downlink (DL)). When an attachment attempt is successful, the communication device can be served by the AP and incoming voice and data traffic can be paged and routed to the communication device through the AP, and outgoing voice and data traffic from the communication device can be paged and routed through the AP to other communication devices in the communication network environment. In an aspect, the communication device can be connected and can communicate wirelessly using virtually any desired wireless technology, including, for example, cellular, Wi-Fi, Wi-Max, wireless local area networks (WLAN), etc.

In another aspect, the communication network 408 can comprise a core network 412 (e.g., mobile core network) that can be employed to facilitate communication (e.g., voice, data) by wireless communication devices (e.g., 402) associated (e.g., wirelessly connected) with the core network 412, via the AP 410, and other communication devices (e.g., 404) associated with the communication network 408. The core network 412 can facilitate routing voice and data communications between communication devices (e.g., TMC, phone, computer, server, multimedia server, audio server, video server, news server, financial or stock information server, other communication devices associated with an IP-based network 414 (e.g., the Internet), etc.) associated with the communication network 408. The core network 412 also can allocate resources to the a wireless communication device(s) (e.g., 402) associated with the core network 412, convert or enforce protocols, establish and enforce Quality of Service (QoS) for the wireless communication devices, provide applications or services in the network, translate signals, and/or perform other desired functions to facilitate system interoperability and communication in the wireless communication network. The core network 412 further can include desired components, such as routers, nodes, switches, interfaces, controllers, etc., that can facilitate communication of data between communication devices associated with the communication network 408.

The communication network 408 also can include the IP-based network 414 that can be associated with the core network 412 and can facilitate communications by communication devices associated with the communication network 408 at least in part via communication of data packets (e.g., IP-based data packets) between communication devices that are associated with the communication network 408 using a wired or wireless communication connection in accordance with specified IP protocols. The IP-based network 414 further can include desired components, such as routers, nodes, switches, interfaces, controllers, etc., that can facilitate communication of data between communication devices associated with the communication network 408. In an aspect, a wireline communication connection between a communication device (e.g., communication device 404, TMC 406) and the IP-based network 414 can be a communication connection that can communicate voice or data, and/or can be a DSL-type or broadband connection facilitated via an Ethernet connection, and/or a wireless communication connection can be facilitated via a connection of the wireless communication device to an AP (e.g., 410). In accordance with various aspects, the communication device can transmit voice calls or data (e.g., messages) via a wireline or wireless connection through the IP-based network 414, the core network 412, or other communication networks, to other communication devices.

In accordance with yet another aspect, the first communication device 402 and second communication device 404 can establish a direct communication channel with each other to exchange information, such as information relating to fund transfers (e.g., fund transfer message, secure token, etc.), using NFC or other communication technology, as more fully described herein.

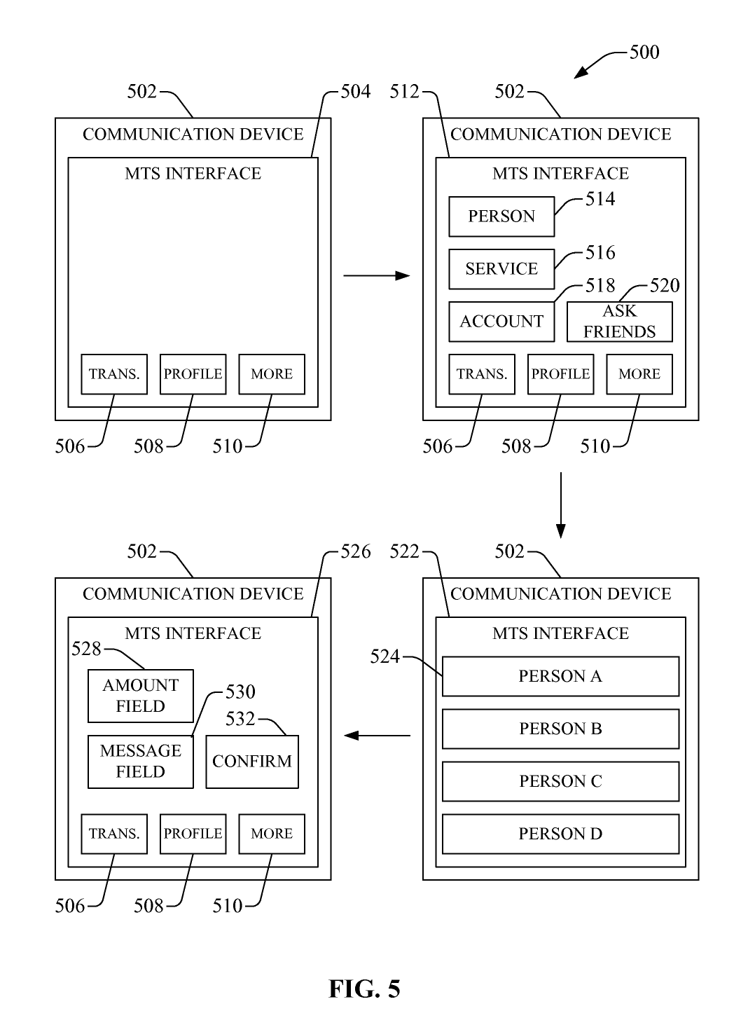

FIG. 5 presents a diagram of an example fund transfer message generation flow 500 that can facilitate generating and sending a fund transfer request (e.g., MTS fund transfer request) using a web or mobile MTS application interface in accordance with various aspects of the disclosed subject matter. In the example fund transfer message generation flow 500, the communication device 502 can employ a web or mobile MTS application to generate and transmit a fund transfer request. The mobile TMC (not shown in FIG. 5) on the communication device 502 can control the process of generating and sending a fund transfer request. The user can be authenticated before being able to access at least portions of the information secured by the web or mobile MTS application.

When the web or mobile MTS application is opened or accessed by the communication device 502, an MTS interface 504 can be displayed wherein the MTS interface can comprise a plurality of controls, such as, for example, a transfer control 506 that can be selected to facilitate generating a fund transfer request, a profile control 508 that can be selected to access, display or modify information in a user profile associated with the communication device user, and/or a more control 510 that can be selected to display additional controls or features of the web or mobile MTS application. The user can select the transfer control 506 to create a new fund transfer request.

In response to the selection of the transfer control 506, the web or mobile MTS application can display a plurality of controls relating to generating the fund transfer request, wherein the plurality of controls can include, for example, a person control 514 (e.g., contact list control) that can be selected to display the contact list, a service control 516 that can be employed to display available services associated with the MTS, an account control 518 that can display information regarding the service account or other accounts the user has registered with the TMC of the MTS, and/or an ask-friends-for-money control 520 that can be used to generate and send a message to a friend to request money from the friend. The user can select the person control 514 to view the contact list.

In response to the selection of the person control 514, the application can display the contact list 522 (e.g., stored on the communication device 502, or stored on the TMC), which can comprise a plurality of contacts associated with the user. The user can select a desired contact, such as Person A 524, and, in response, the mobile TMC can update the fund transfer request to include Person A 524 and information relating to Person A 524 in the fund transfer request. Further, in response to the selection of the person control 514, the mobile TMC can display a message 526 (e.g., MTS message) in the application interface that indicates that Person A 524 is the intended recipient of the fund transfer. The application interface also can comprise, for example, an amount field 528 wherein the desired amount to be transferred can be entered by the user, a message field 530 wherein the user can enter a personal message to the intended recipient, if desired, and/or a confirm control 532 that can be used to confirm the information in the fund transfer request and/or transmit the fund transfer request. In response to selection of the selection of the confirm control 532 and/or a send transfer request control (not shown), the fund transfer request can be submitted to the TMC of the MTS for processing of the fund transfer request.

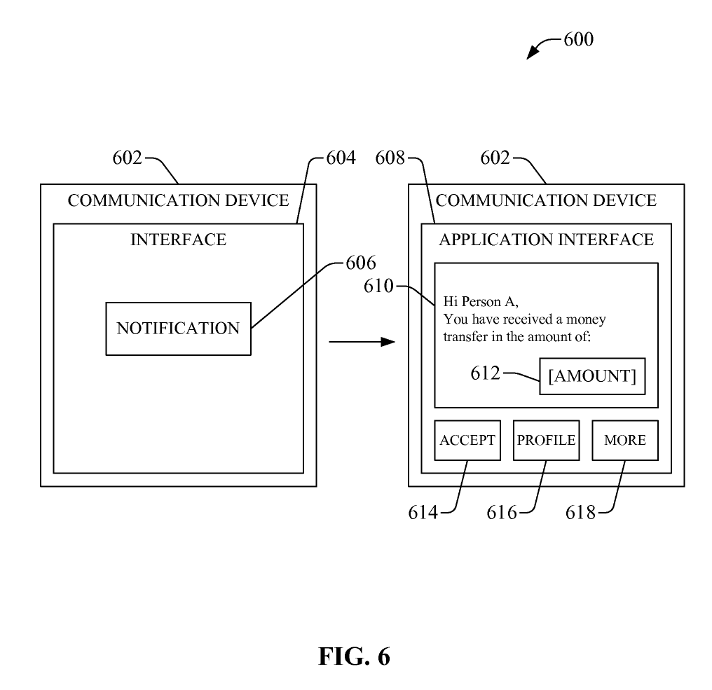

FIG. 6 illustrates a block diagram of an example fund transfer message receipt flow 600 that can facilitate receiving and obtaining funds associated with a fund transfer message (e.g., MTS fund transfer message) using a web or mobile MTS application interface in accordance with various aspects of the disclosed subject matter. In the example fund transfer message receipt flow 600, the communication device 602 can employ a web or mobile MTS application to display and interact with a received fund transfer message. The mobile TMC (not shown in FIG. 6) on the communication device 602 can control the process of obtaining, withdrawing, or depositing of funds received as part of the fund transfer message. The user can be authenticated before being able to access at least portions of the information secured by the web or mobile MTS application.

The TMC of the MTS can transmit the fund transfer message to the communication device 602. An interface 604 on the communication device 602 can present (e.g., display) a fund transfer notification 606 to the user. The user can select the notification 606, and, in response, the mobile TMC can open the web or mobile MTS application and/or request the user to authenticate (if this is not already done). When the application is opened, the mobile TMC can display an application interface 608 that can comprise a fund transfer message 610 comprising information notifying the intended recipient (e.g., Person A) that funds have been transferred to the intended recipient and can specify the fund amount 612. The application interface 608 also can include a plurality of controls, such as, for example, an accept money control 614 (also referred to as “ACCEPT” in FIG. 6) that can be selected to accept the fund transfer and/or take other desired action with regard to the transferred funds (e.g., withdraw funds, deposit funds, pay bill with funds, etc.), a profile control 616 that can be selected to access, display or modify information in a user profile associated with the intended recipient, and/or a more control 618 that can be selected to display additional controls or features of the web or mobile MTS application.

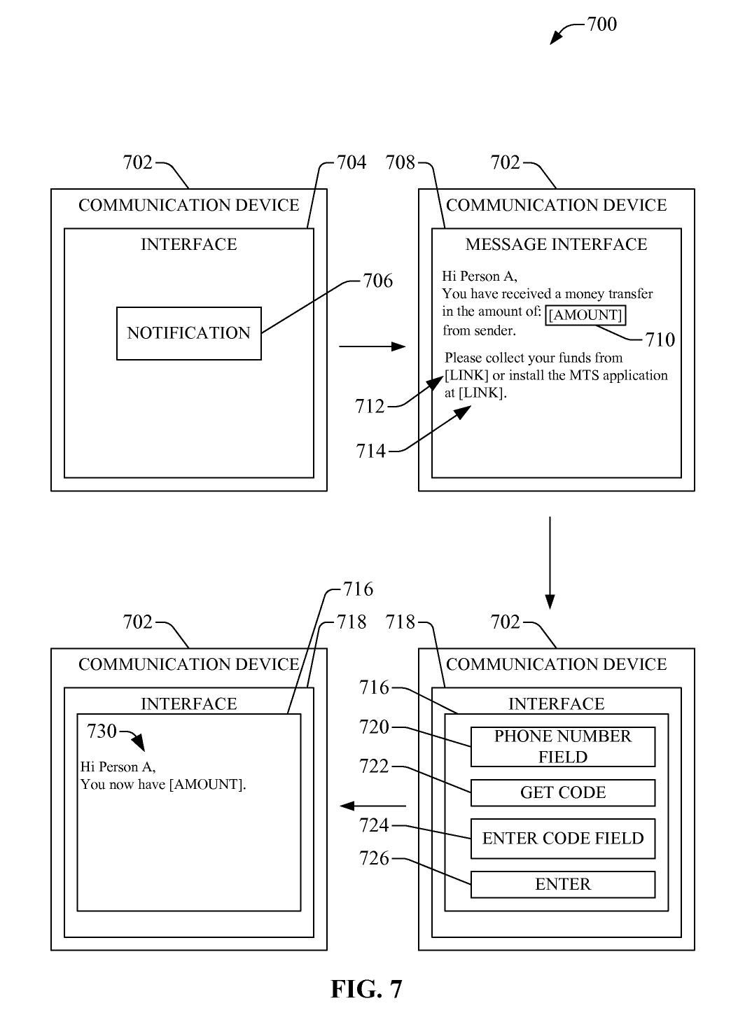

FIG. 7 depicts a block diagram of an example fund transfer message receipt flow 700 that can facilitate receiving and obtaining funds associated with a fund transfer message using a message application interface in accordance with various aspects of the disclosed subject matter. In the example fund transfer message receipt flow 700, the communication device 702 can employ a message application and interface to display and interact with a received fund transfer message (e.g., text, IM, multimedia, or email message). The communication device 702 can control the process of obtaining, withdrawing, or depositing of funds received as part of the fund transfer message.

The TMC of the MTS can transmit the fund transfer message (e.g., text, IM, multimedia, or email message) to the communication device 702. An interface 704, which can be a main interface or a message application interface, on the communication device 702 can present (e.g., display) a fund transfer notification 706 to the user. The user can select the notification 706, and, in response, the communication device 702 can open the message application and/or request the user to authenticate (if this is not already done). When the message application is opened, the communication device 702 can display a message interface 708 that can comprise a fund transfer message for the intended recipient (e.g., Person A), wherein the fund transfer message can comprise information indicating that funds have been transferred to the intended recipient and can specify the fund amount 710. The fund transfer message also can include a link 712 that can be used to accept and/or obtain the fund transfer, wherein the link 712 can be a unique link (e.g., unique hyperlink) to a web page associated with the TMC of the MTS, wherein the web page can comprise information and controls that can facilitate enabling the intended recipient to accept, obtain and/or take another desired action with regard to the transferred funds, and/or the message can request the intended recipient to download the MTS application and can include a link 714 that can open up an online page (e.g., web page) that can be associated with or can include a download control that can be used to download the MTS application on the communication device 702, if desired by the intended recipient.

In an aspect, in response to the intended recipient selecting the link 712 in the message interface, the communication device 702 can open the online page 716 associated with the link 712 and can present the online page 716 in an interface 718 to the intended recipient, wherein the interface 718 can be a message interface or a web browser interface. The online page 716 can comprise information that can facilitate enabling the intended recipient to obtain the funds and/or can require that the intended recipient validate or authenticate with the TMC of the MTS to prove the communication device 702 is the device associated with the intended recipient of the funds transfer request and/or the intended recipient is authorized to obtain the funds. For example, the interface 718 can comprise a phone number field 720 (or email address field, if the message was sent to the email) and the TMC can require that the intended recipient enter the phone number (or email address, if the message was sent to the email) of the communication device 702; can include a code control 722 that, when selected by the intended recipient in the interface 718, can result in the TMC sending a validation or authorization code to the phone number (or email address) in the phone number field 720 (or email address field); and can include an enter code field 724 wherein the intended recipient can enter the validation or authorization code received by the communication device 702 from the TMC. The online page 718 also can contain an enter control 726, and the intended recipient can select the enter control field after the required information has been input to the specified fields. In response to validating, authenticating or authorizing the intended recipient (e.g., upon receipt of a valid phone number or email address, and a proper validation or authorization code), the TMC can authorize the intended recipient to obtain the transferred funds. The online page 716 (or another online page) can present a message 730 to the intended recipient that indicates the amount of funds the intended recipient has available. The intended recipient, via the online page 718 or another online page associated with the TMC, can provide the TMC with information, such as account information of the intended recipient, and the TMC can transfer the funds to the account or other destination specified by the intended recipient, or the intended recipient can request that the TMC transmit a secure token, comprising the funds or information enabling the secure token to be used to access the funds, to the communication device 702 or another desired destination (e.g., email the secure token to the intended recipient's email address). When a secure token is provided to the intended recipient, the intended recipient can use the secure token in a manner as more fully described herein.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

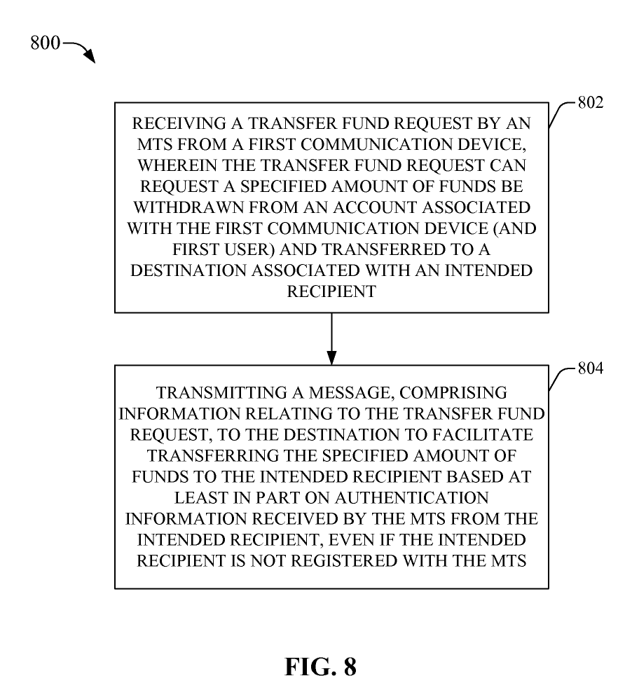

In view of the example systems described above, example methods that can be implemented in accordance with the disclosed subject matter can be better appreciated with reference to flowcharts in FIGS. 8-18. For purposes of simplicity of explanation, various methods disclosed herein are presented and described as a series of acts; however, it is to be understood and appreciated that the subject disclosure is not limited by the order of acts, as some acts may occur in different order and/or concurrently with other acts from that shown and described herein. It is noted that not all illustrated acts may be required to implement a described method in accordance with the subject specification. In addition, for example, one or more methods disclosed herein could alternatively be represented as a series of interrelated states or events, such as in a state diagram. Moreover, interaction diagram(s) or call flow(s) represent several of the example methods disclosed herein in accordance with the described subject matter; particularly in instances when disparate entities, or functional elements, enact disparate portions of one or more of the several methods. Furthermore, two or more of the disclosed example methods can be implemented in combination, to accomplish one or more features or advantages described in the subject disclosure.

With reference first to FIG. 8, illustrated is a flow chart of an example method 800 for transferring money using personal communication devices, in accordance with various aspects and embodiments. At 802, a transfer fund request can be received by a money transfer service (MTS) from a first communication device, wherein the transfer fund request can request a specified amount of funds be withdrawn from an account associated with the first communication device (and first user) and transferred to a destination associated with an intended recipient. In an aspect, the first user can use the first communication device to generate and transmit the fund transfer request. The fund transfer request can be transmitted to a TMC associated with the MTS, wherein the TMC can generate a message relating to the fund transfer request.

At 804, a message, comprising information relating to the transfer fund request, can be transmitted to the destination associated with the intended recipient to facilitate transferring the specified amount of funds to the intended recipient based at least in part on authentication information received by the MTS (e.g., TMC of the MTS) from the intended recipient, even if the intended recipient is not registered with the MTS (e.g., registered with TMC of the MTS). In accordance with various aspects, the message can be an MTS message, a text message, an IM, a multimedia message, an email message, or a voice mail message, etc. The message can comprise information, such as a link to an online page associated with the MTS wherein the specified amount of funds can be obtained (e.g., withdrawn, deposited to another account, used to pay a bill, etc.) by the intended recipient, a secure token that comprises the specified amount of funds or information relating to the specified amount of funds, a personal message from the payee associated with the fund transfer request, and/or other information. The destination can be a second communication device associated with the intended recipient or an email account of the intended recipient which can be accessed using the second communication device, for example.

In an aspect, if the message comprises a link that can be used to obtain the specified amount of funds, the intended recipient can use the second communication device to select the link and, in response, an online page associated with the link can be opened and displayed on an interface (e.g., web browser interface) of the second communication device. The online page can request the intended recipient present an address (e.g., phone number, email address) associated with the second communication device and/or a code (e.g., validation, authorization or authentication code), wherein the code can be sent by the TMC to the second communication device at the address presented by the intended recipient via the second communication device. The TMC can authorize the intended recipient to obtain the transferred funds when the intended recipient presents a valid code.

In another aspect, if the message comprises a secure token that includes the transferred funds, the intended recipient can obtain the funds by using a specified code or key, wherein the code or key can be received from the first user or the TMC or known by the intended recipient. For example, the first user via the first communication device and/or TMC can secure the secure token using a desired code (e.g., password, challenge and response, PIN, etc.), which the first user can send to the intended recipient (e.g., at the second communication device) via a separate message or which can be previously known by the intended recipient, or the TMC can generate the code or key and secure the secure token using the code or key (e.g., to lock the secure token and/or encrypt the data contained in the secure token). The intended recipient, using the second communication device, can select the secure token, and the secure token can request that a proper code or key be entered in order to unlock the secure token (and transferred funds therein) and/or decrypt the data, including data relating to the transferred funds, contained in the secure token. The secure token can be unlocked and/or its data decrypted, when the proper code or key is entered, and the funds can be available on the second communication device for use by the intended recipient.

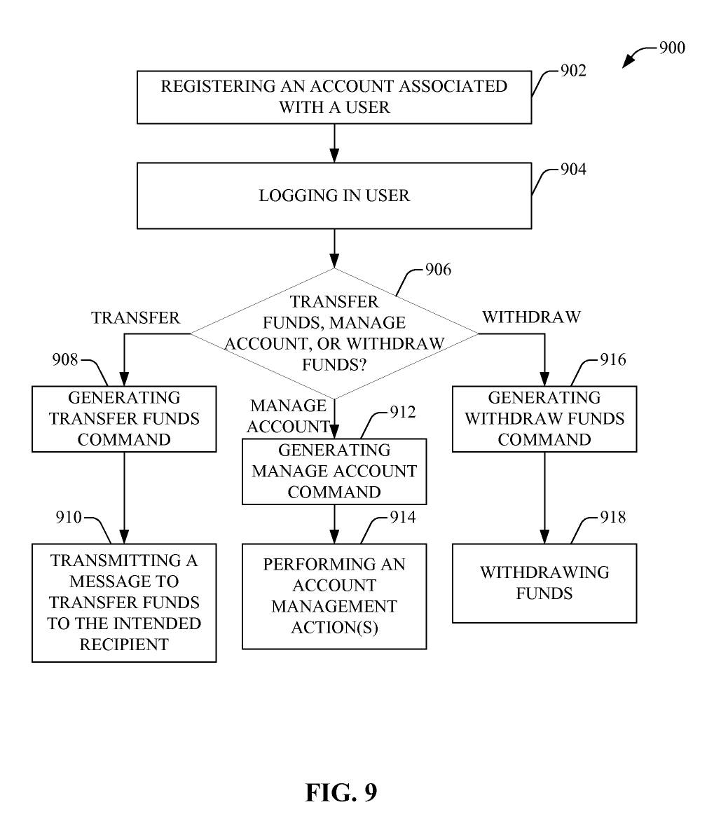

Referring next to FIG. 9, depicted is a flow chart of an example a method 900 for managing monetary transfers in accordance with various aspects and embodiments. At 902, an account associated with a user can be registered. For example, a user can use a communication device to register an account that can be used to transfer money or receive money. As part of the registration of the user, authentication credentials, such as, for example, a username, password, passphrase, personal identification number (PIN), unique biometric information associated with the user can be created by the user and/or TMC, and stored by the TMC. The stored authentication credentials associated with the user can be used during a login process to authenticate or verify the user and to determine access rights to be granted to the user in relation to financial transfers associated with the transaction system.

At 904, the user can be logged in to the TMC in response to receiving valid authentication credentials from the user. The user can use a communication device to enter authentication credentials via an application interface or online (e.g., web) interface, and the authentication credentials can be transmitted to the TMC to log into the transaction system. At 906, a determination can be made as to whether to transfer (e.g., send) funds, view or manage the account, or receive funds.

If, at 906, the determination is to transfer funds, at 908, a transfer funds command can be generated. For instance, in response to selection of a transfer funds control on the communication device by the user, a transfer funds command can be generated. Other information, such as the amount of funds, the intended recipient and associated address information can be selected on or received by the communication device, as part of the transfer funds transaction. At 910, a message to transfer funds to the intended recipient can be transmitted. The user can employ the communication device to generate and transmit a message, such as an instant message, a text message, a notification via a web or mobile application, or an MTS message, etc., from the communication device to an intended destination, which can be an address (e.g., email address, phone number, account number, IP address, etc.) associated with or accessible by a communication device of the intended recipient. The message can include information indicating the amount of funds being transferred to the intended recipient. The TMC can manage the sending of funds to the intended recipient, wherein the transfer management component can receive the message from the sending communication device and/or can generate a corresponding message that can be forwarded to the address of the intended recipient.

Referring again to act 906, if, at 906, the determination is to view or manage the account, at 912, a manage account funds command can be generated. For instance, in response to selection of a view or manage account control on the communication device by the user, a view or manage account command can be generated and transmitted to the TMC. At 914, one or more account management actions can be performed. For example, the communication device can be used to transmit a request (e.g., one-time request) that funds be manually withdrawn or deposited into the account, and the TMC can receive the request and withdraw funds from or deposit funds into the account, wherein the funds can be provided to or received from, for example, another account, such as another account associated with the user. As another example, the communication device can be used to transmit a request that funds be automatically withdrawn or deposited into the account (e.g., on a periodic basis), and the TMC can receive the request and can set up the user's account to automatically withdraw funds from or deposit funds into the account, wherein the funds can be provided to or received from, for example, another account, such as another account associated with the user and registered with or accessible by the TMC. As still another example, the communication device can be used to transmit a request that add (e.g., register), remove, or modify an account, and the TMC can receive the request and can add, remove, or modify an account in accordance with the information provided by the user via the communication device as part of the request.

Referring again to act 906, if, at 906, the determination is to receive funds, at 916, a receive funds command can be generated. For instance, in response to selection of a receive funds control (or withdraw funds control) on the communication device by the user, a receive funds command can be generated and sent to the TMC. The user can decide to transmit a receive funds request to receive or withdraw the funds sent to the user, for example, in response to receiving a message (e.g., an instant message, a text message, a notification via a web or mobile application, or an MTS message, etc.) indicating that the user has been sent a specified amount of funds from a funds sender. At 918, a desired amount of funds (e.g., all or a portion of funds transferred to the user) can be withdrawn from an account (e.g., service account, bank or debit account, etc.) associated with the user.

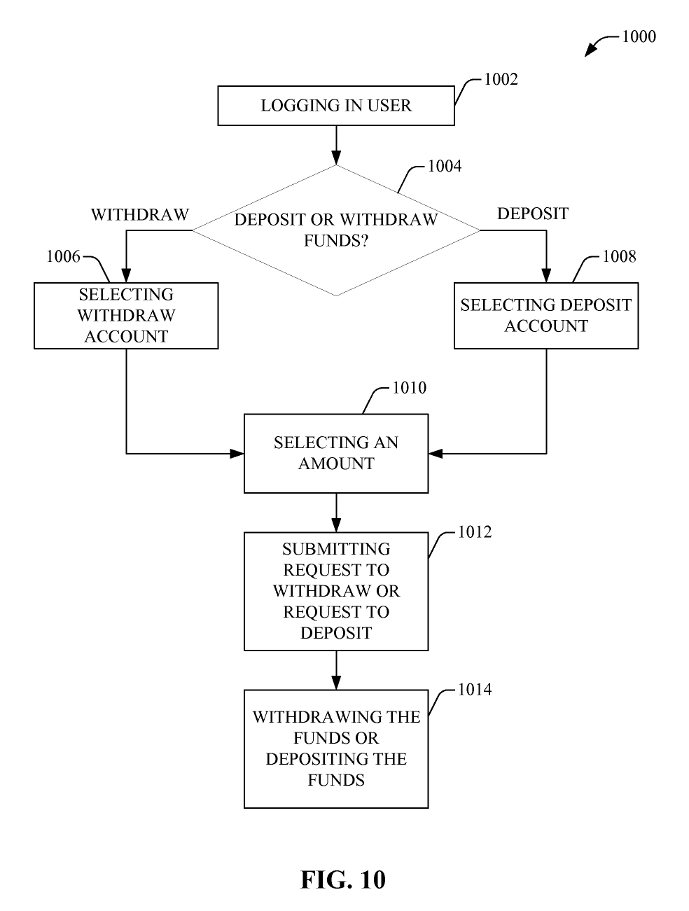

Turning to FIG. 10, illustrated is a flow chart of an example method 1000 for manually depositing funds into or withdrawing funds from an account associated with a user in accordance with various aspects and embodiments. At 1002, a user can be logged in to a transaction system in response to receiving valid authentication credentials from the user. The user can use a communication device to enter authentication credentials via an application interface or online (e.g., web) interface, and the authentication credentials can be transmitted to the TMC to log the user into the transaction system. At 1004, a determination can be made as to whether to withdraw funds from or deposit funds into an account associated with the user and registered with the TMC.

If, at act 1004, the determination was to withdraw funds from an account, at 1006, a withdraw account can be selected. For instance, the user can use the UI of the communication device to select a withdraw funds control in the UI, and the communication device can receive the selection to withdraw funds. The communication device can communicate the withdraw funds request to the TMC immediately in response to receiving the selection or can wait for additional information from the user relating to the withdraw request and can transmit the withdraw request and additional related information to the TMC. At this point, the method 1000 can proceed to act 1010 and can proceed from that point.

If, at act 1004, the determination was to deposit funds from an account, at 1008, a deposit account can be selected. For instance, the user can use the UI of the communication device to select a deposit funds control in the UI, and the communication device can receive the selection to deposit funds. The communication device can communicate the deposit funds request to the TMC immediately in response to receiving the selection or can wait for additional information from the user relating to the deposit request and can transmit the deposit request and additional related information to the TMC. At this point, the method 1000 can proceed to act 1010 and can proceed from that point.

At 1010, an amount of funds to withdraw or deposit can be selected. The user can select an amount of funds to withdraw or deposit via the UI of the communication device, and the amount of funds to withdraw or deposit selected can be communicated to the TMC from the communication device as part of the request to withdraw or request to deposit. The request to withdraw can comprise other information indicating the account from which to withdraw the funds, or the request to deposit can comprise other information indicating the account in which the funds are to be deposited. In an aspect, the request can be a hybrid or multiple-transaction request, wherein the user is withdrawing funds from one account and depositing the funds into another account. At 1012, the request to withdraw or request to deposit can be submitted (e.g., transmitted). For instance, the request to withdraw or request to deposit can be transmitted from the communication device to the transfer management component so that the desired request can be processed. At 1014, the selected amount of funds can be withdrawn from or deposited into the selected account. For instance, the TMC can withdraw funds from an account specified in the request to withdraw and can apply (e.g., deposit, pay) those funds to another account associated with the user, a credit card account, a utility account, etc., as specified in the request to withdraw, or the TMC can deposit funds into an account specified in the request to deposit from another account associated with the user or a received transfer from another user via the other user's communication device (e.g., as specified in the request to deposit).

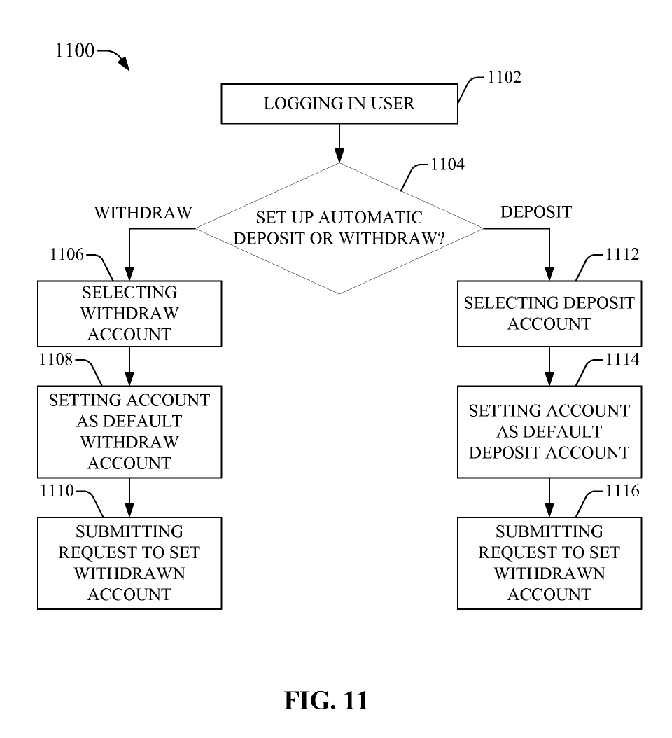

Referring to FIG. 11, depicted is a flow chart of an example method 1100 for automatically depositing funds into or withdrawing funds from an account associated with a user in accordance with various aspects and embodiments. At 1102, a user can be logged in to a transaction system in response to receiving valid authentication credentials from the user. The user can use a communication device to enter authentication credentials via an application interface or online (e.g., web) interface, and the authentication credentials can be transmitted to the TMC to log the user into the TMC and associated MTS. At 1104, a determination can be made as to whether to set up an account as an automatic withdraw account to automatically withdraw funds for deposit into a service account of the user, for example, when the account balance of the service account is below a predefined minimum amount of funds, or to set an account as an automatic deposit account associated with the user to automatically deposit funds into the automatic deposit account from the service account when any or a specified amount of funds are deposited into the service account.

If, at act 1104, the determination was to set up an account to automatically withdraw funds from the account and deposit the funds into the service account, at 1106, an account can be selected as a withdraw account to facilitate setting up the account so that a specified amount of funds can be automatically withdrawn from the account and deposited into the service account, for example, when the account balance of the service account is below the predefined minimum amount of funds. For instance, the user can use the UI of the communication device to select to set up the automatic withdraw funds control in the UI, and the communication device can receive the selection to set up the automatic withdrawal of funds from the account specified as part of the selection. As described herein, the communication device can communicate the automatic withdraw funds selection (e.g., as part of a request) to the TMC immediately in response to receiving the selection or can wait for additional information from the user relating to the automatic withdraw funds selection and can transmit the automatic withdraw funds selection and additional related information to the TMC.

At 1108, the account can be set as a default withdraw account, wherein the default withdraw account can be used to withdraw funds to deposit into the service account associated with the user when the amount of funds in the service account is below the predefined minimum threshold amount of funds. The amount of funds automatically withdrawn from the account and deposited into the service account can be specified or can be dynamic (e.g., based at least in part on the amount of funds available in the account). As desired one or more additional accounts can be set up as default withdraw accounts (e.g., secondary default withdraw account) in case the default withdraw account does not have the desired amount of funds that can be automatically withdrawn for deposit into the service account. The TMC can set the account as the automatic withdraw account in response to receiving the request from the communication device, and can manage fund transfers between the withdraw account and the service account in accordance with the request.

At 1110, the request to set the account as an automatic withdraw account can be submitted. For instance, the user can employ the communication device to transmit the request to set the account as an automatic withdraw account to the TMC, wherein the request can comprise the account selected as the default withdraw account, predefined minimum threshold amount of funds, and/or the default withdraw amount.

Referring again to act 1104, if, at act 1104, the determination was to set up an account to automatically deposit funds (e.g., a specified amount of funds) into the account from funds available from the service account, at 1112, an account can be selected as a default deposit account to facilitate automatically depositing funds into the account from funds available in the service account, for example, when funds are received by the service account, the account balance of the account is below a predefined minimum threshold amount of funds, or the account balance of the service account is above a predefined threshold maximum amount of funds. For instance, the user can use the UI of the communication device to select to set up the automatic deposit funds control in the UI, and the communication device can receive the selection to set up the automatic deposit of funds into the account specified as part of the selection from the service account, for example, when funds are received by the service account, the account balance of the account is below a predefined minimum threshold amount of funds, or the account balance of the service account is above a predefined threshold maximum amount of funds. As described herein, the communication device can communicate the automatic deposit funds selection (e.g., as part of a request) to the transfer management component immediately in response to receiving the selection or can wait for additional information from the user relating to the automatic deposit funds selection and can transmit the automatic deposit funds selection and additional related information to the TMC.

At 1114, the account can be set as a default deposit account, wherein the default deposit account can be used for fund deposits from the service account as specified in the request. The amount of funds automatically deposited into the account can be specified (e.g., deposit $50 when the service account has at least $50) or can be dynamic (e.g., when the service account receives funds or based at least in part on the amount of funds available in the service account). As desired one or more additional accounts can be set up as default deposit accounts (e.g., secondary default deposit account) to receive at least a portion of funds from the service account.

At 1116, the request to set the account as an automatic deposit account can be submitted. For instance, the user can employ the communication device to transmit the request to set the account as an automatic deposit account to the TMC, wherein the request can comprise the account selected as the default deposit account and the default deposit amount. The TMC can set the account as the automatic deposit account in response to receiving the request from the communication device, and can manage fund transfers between the account and the service account in accordance with the request.

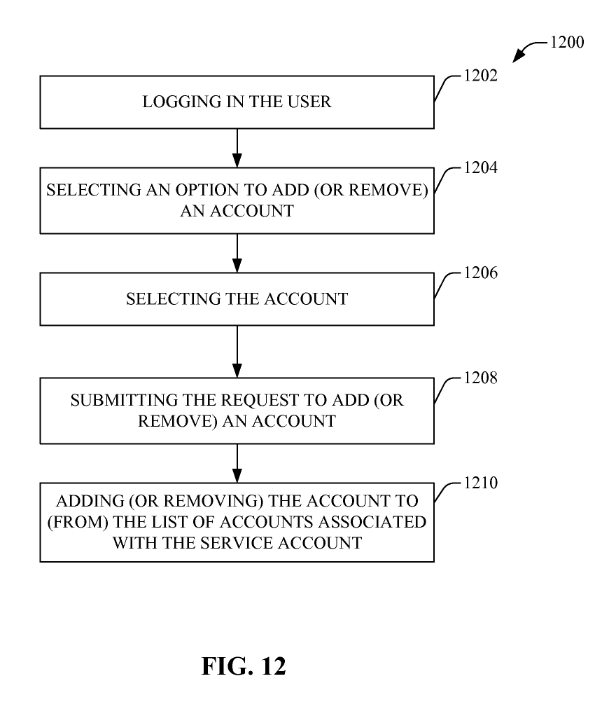

FIG. 12 illustrates a flow chart of an example method 1200 for managing (e.g., adding, removing, or modifying) an account associated with service account of a user in accordance with various aspects and embodiments. At 1202, a user can be logged in to a TMC and associated MTS in response to receiving valid authentication credentials from the user. The user can use a communication device to enter authentication credentials via an application interface or online (e.g., web) interface, and the authentication credentials can be transmitted to the TMC to log the user into the TMC and associated MTS.

At 1204, an option to add (or remove) (e.g., link (or unlink)) an account (e.g., credit card account, debit card account, another financial account) to (from) a list of accounts associated with the service account can be selected. In an aspect, the communication device can receive information to select such option from the user via a UI, wherein the UI can be associated with an application (e.g., mobile application) or an online interface (e.g., from an online web site). At 1206, an account, which is to be added or removed, can be selected, in response to received information from the user. For example, the communication device can select the account in response to the received information, and/or the TMC can select the account in response to the received information, for example, as part of a request to add (or remove) the account to (from) the list of accounts associated with (e.g., linked to) the service account.

At 1208, a request to select the account to add (or remove) the account to (from) the list of accounts associated with the service account can be submitted (e.g., transmitted). The request can be submitted by the communication device to the TMC via the communication network in response to a command (e.g., send or submit command) received by the communication device from the user. At 1210, the account selected for adding or removal can be added or removed from the list of accounts associated with (e.g., linked to) the service account in response to the request.

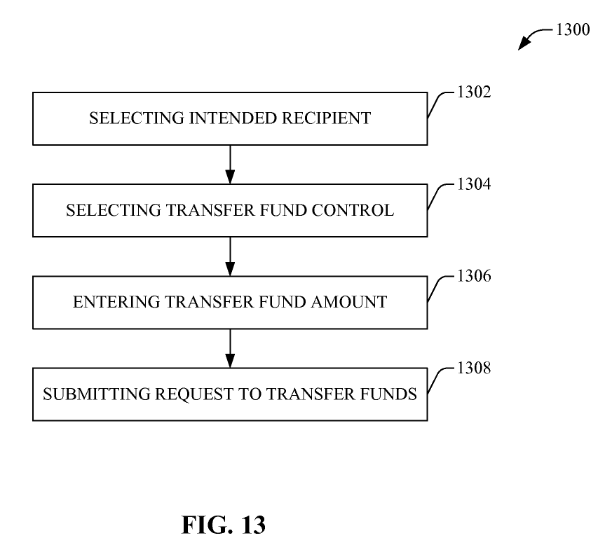

FIG. 13 illustrates a flow chart of an example method 1300 for sending funds via a message interface (e.g., IM interface, text message interface) associated with a service account associated with a user in accordance with various aspects and embodiments. At 1302, an intended fund recipient of a fund transfer can be selected. For instance, the communication device can receive information indicating selection of the intended fund recipient from the user via the UI and the mobile TMC of the communication device can select the intended fund recipient in response. At 1304, a transfer fund control can be selected. For instance, the communication device can receive selection of the transfer fund control from the user via the message interface or another UI. At 1306, an amount of funds to be transferred from the user to the intended fund recipient can be entered. In an aspect, via a UI (e.g., message interface), the communication device can receive information indicating the amount of funds to be transferred from the service account of the user to the intended fund recipient via an address associated with the intended fund recipient, wherein such address can be associated with a service account or other account of the intended fund recipient or can be associated with a physical (e.g., geographical) address where the intended fund recipient can go to pick up the transferred funds. For example, the UI can generate and display a screen or menu, such as a pop-up screen or menu, that can provide a field for the user to enter the desired fund transfer amount and/or predefined fund transfer amounts (e.g., $20, $50, $100, . . . ) that can be selected via the UI, and the user can enter information indicating the desired fund transfer amount via the UI.

At 1308, a request to transfer funds can be submitted (e.g., transmitted). In an aspect, the communication device can generate and transmit the request to transfer funds, comprising information relating to the intended fund recipient, and the amount of money, to the TMC and/or a communication device associated with the intended fund recipient.

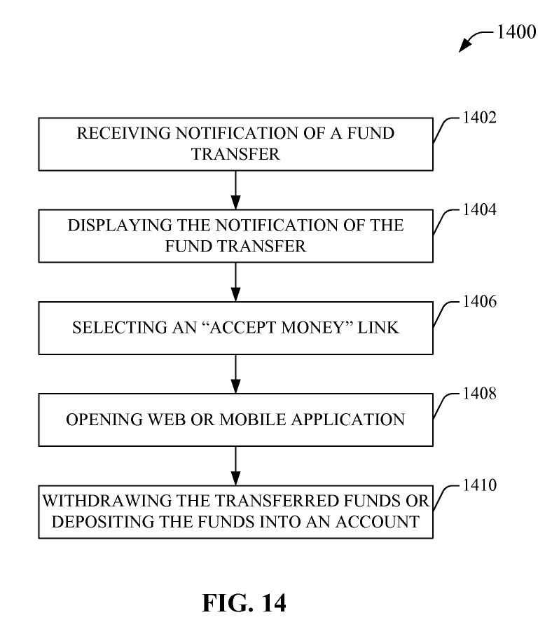

FIG. 14 illustrates a flow chart of an example method 1400 for receiving funds via a message interface (e.g., IM interface, text message interface) associated with a service account associated with a user in accordance with various aspects and embodiments. The method 1400 can be employed, for example, by a communication device that comprises a communication interface that includes transfer money functionality, as more fully described herein.

At 1402, a notification of a fund transfer to the user can be received, for example, by the communication device of the user. The fund transfer can be sent from another communication device of another user who desires to send funds to the receiving user. At 1404, the notification of the fund transfer can be display on the UI (e.g., IM interface or text message interface of the UI) of the communication device. For example, the notification can be displayed in an IM conversation thread between the receiving user and the user who sent the funds. In an aspect, the notification can comprise an “accept money” link (e.g., hyperlink), such as an “accept money” URL link. At 1406, the “accept money” link can be selected. For instance, the communication device can receive information (e.g., input, selection, or gesture on the link or a receive fund transfer control on a touch screen GUI or other UI) via the UI indicating that the user selected the “accept money” link, and the communication device can select the “accept money” link in response to the received information.

At 1408, in response to the selection of the “accept money” link, an application, such as a web or mobile application, can be opened. The application can be opened to facilitate establishing communication (e.g., secure communication) between the communication device and the transfer service associated with a service account associated with the user (e.g., receiving user), the sending user, and/or the application. At 1410, the funds associated with the notification can be deposited (e.g., automatically) into a specified account associated with the receiving user or withdrawn (e.g., automatically) for use by the intended recipient. The specified account can be the service account of the intended recipient (if the intended recipient has a service account with transfer service) or a default account as specified by intended recipient in that intended recipient's user preferences. As desired, the intended recipient also can make an immediate and/or automatic withdrawal of the transferred funds.

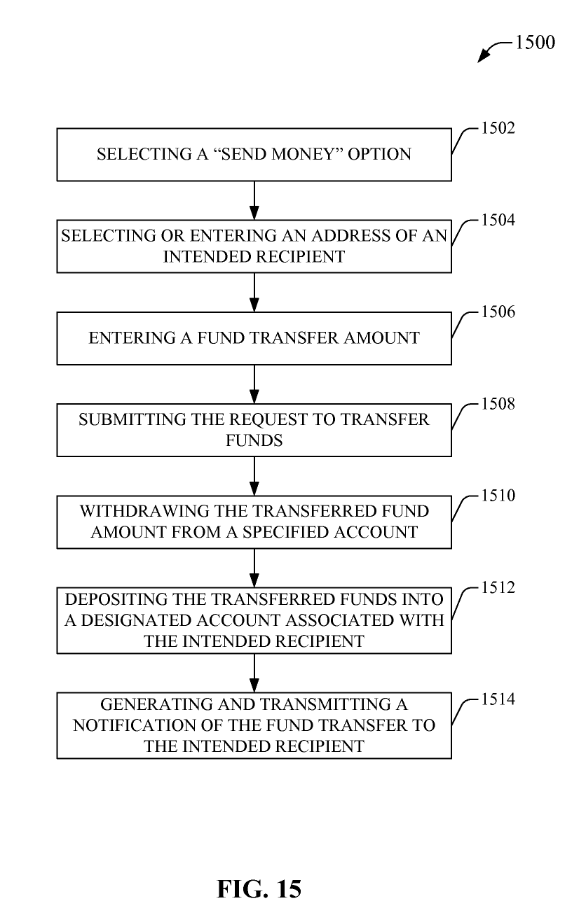

FIG. 15 presents a flow chart of an example method 1500 for transferring funds via an application interface (e.g., web or mobile application interface) associated with a service account associated with a user in accordance with various aspects and embodiments. The method 1500 can be employed, for example, at least partially by a communication device that comprises a communication interface that includes transfer money functionality, as more fully described herein. At 1502, a “send money” control or option can be selected. The communication device can receive information such as, for example, an input, a selection, or a gesture indicating selection of a “send money” control or option on a touch screen GUI or other UI associated with a web or mobile application interface. The communication device can select or engage the “send money” control or option in response to the received information.

At 1504, an address associated with an intended recipient of the funds can be entered or selected. For instance, the communication device can receive information, such as, for example, an input, a selection, or a gesture indicating selection of an address, such as a service ID (e.g., associated with the intended recipient's service account), phone number, email address, etc., associated with the intended recipient via a touch screen GUI or other UI associated with the web or mobile application interface. The communication device can select or engage the selected item (e.g., intended recipient's name and/or address) in response to the received information. In an aspect, when the funds are transferred to the intended recipient, the funds transfer can be performed by the TMC in accordance with the configuration settings of the intended recipient as specified in the user preferences of the intended recipient.

At 1506, an amount of funds to be transferred from the user to the intended recipient can be entered. In an aspect, via a UI associated with the web or mobile interface, the communication device can receive information indicating the amount of funds to be transferred from the service account (or other associated account) of the user to the intended recipient via the selected address associated with the intended recipient, wherein such address can be associated with a service account or other account of the intended recipient or can be associated with a physical (e.g., geographical) address where the intended recipient can go to pick up the transferred funds. For example, the web or mobile application can generate and display a screen or menu, such as a pop-up screen or menu, that can provide a field for the user to enter the desired fund transfer amount and/or predefined fund transfer amounts that can be selected via the UI, and the user can enter information indicating the desired fund transfer amount via the UI.

At 1508, the request to transfer funds can be submitted (e.g., transmitted). In an aspect, the communication device can generate and transmit the request to transfer funds, comprising information relating to the intended recipient, and the amount of money to be transferred, to the TMC and/or a communication device associated with the intended recipient. At 1510, the amount of funds transferred can be removed from a specified account of the user (e.g., payer), in accordance with the user's user preferences, wherein the specified account can be the service account or another desired account associated with the user. For instance, the TMC can analyze information associated with the fund transfer request, and the user preferences of the user, and can remove the funds from the specified account of the user.

At 1512, the funds being transferred can be deposited into a designated account associated with the intended recipient, in accordance with the user preferences of the intended recipient. The TMC can transfer the funds associated with the request by withdrawing the funds from the specified account of the payer and depositing those funds into the designated account of the intended recipient.

At 1514, a notification of the funds transfer can be generated and transmitted to a UI of the intended recipient's communication device and/or other destination (e.g., email inbox) associated with the intended recipient. In accordance with various aspects, the TMC can generate the notification comprising information, including the amount of the funds transferred, information indicating or relating to the payer, an “accept money” URL link, and/or other information (e.g., personal message from the payer), and can transmit the notification to the UI (e.g., of the web or mobile application, an IM UI, or a text UI) of a communication device associated with the intended recipient. For instance, the notification can be an MTS message that can be sent to the UI associated with the web or mobile application interface, as more fully described herein. Additionally or alternatively, the notification can be in the form of an email message sent to the intended recipient's email address, a text or multimedia message sent addressed to the phone number associated with the intended recipient.

The notification can be received by the communication device of the intended recipient, as more fully described herein. The funds associated with the transfer can be deposited into a designated account of the intended recipient and/or withdrawn by the intended recipient, as desired (e.g., in accordance with the user preferences or selections of the intended recipient).

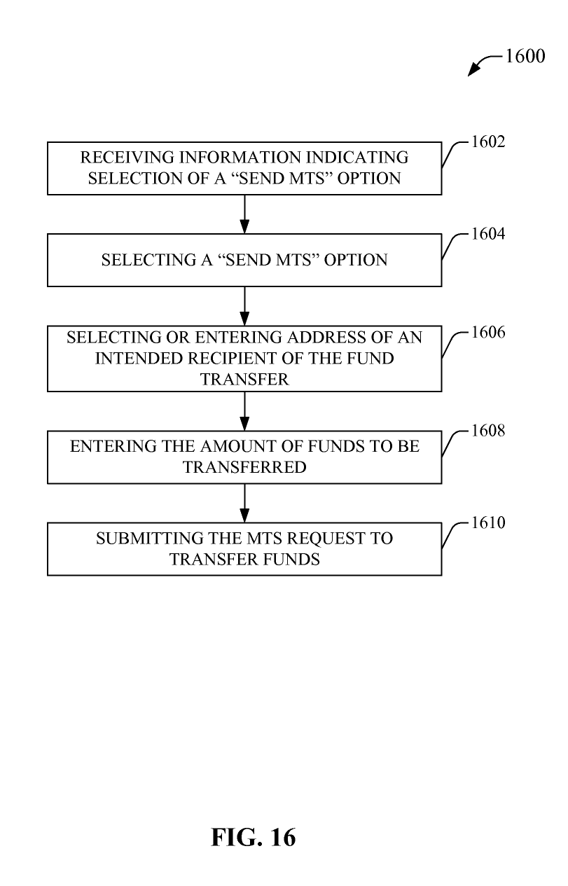

FIG. 16 illustrates a flow chart of an example method 1600 for transferring funds via an application interface (e.g., web or mobile application interface) associated with a service account associated with a user in relation to a MTS in accordance with various aspects and embodiments. The method 1600 can be employed, for example, at least partially by a communication device that comprises a communication interface that includes MTS functionality, as more fully described herein. At 1602, information indicating selection of a “send MTS” control or option can be received. The communication device can receive information, such as, for example, an input, a selection, or a gesture indicating selection of a “send MTS” control or option on a touch screen GUI or other UI associated with a web or mobile application interface. The “send MTS” control or option can be employed to transfer funds from an account associated with the payer to an intended recipient (e.g., payee) via use of the payer's communication device and the intended recipient's communication device, for example, with each communication device comprising MTS functionality. At 1604, the “send MTS” control or option can be selected in response to the received information. For instance, the communication device can select or engage the “send MTS” control or option in response to the received information.

At 1606, the intended recipient, and/or an address associated with the intended recipient, can be selected or entered in response to received information indicating selection of the intended recipient. The received information can comprise, for example, an input, a selection, or a gesture indicating selection of an address, such as a service ID (e.g., associated with the intended recipient's service account), phone number, email address, etc., associated with the intended recipient via a touch screen GUI or other UI associated with the web or mobile application interface. The application associated with the payer's communication device can select or engage the selected item (e.g., intended recipient's name and/or address) in response to the received information.

At 1608, an amount of funds to be transferred from the payer to the intended recipient can be entered or selected as part of the MTS fund transfer request in response to received information indicating the amount of funds to be transferred. In an aspect, via a UI associated with the web or mobile interface, the communication device can receive information indicating the amount of funds to be transferred from the service account (or other associated account) of the payer to the intended recipient via the selected address associated with the intended recipient. For example, the web or mobile application can generate and display a screen or menu, such as a pop-up screen or menu, that can provide a field for the user to enter the desired fund transfer amount and/or predefined fund transfer amounts that can be selected via the UI, and the user can submit (e.g., enter) information indicating the desired fund transfer amount via the UI. In another aspect, the payer optionally can submit a personal message (e.g., IM or text message) that can be included as part of the MTS message.

At 1610, the request to transfer funds can be submitted (e.g., transmitted). In an aspect, the communication device can generate and transmit the request to transfer funds, comprising information relating to the intended recipient, and the amount of money to be transferred, to the TMC and/or a communication device associated with the intended recipient.

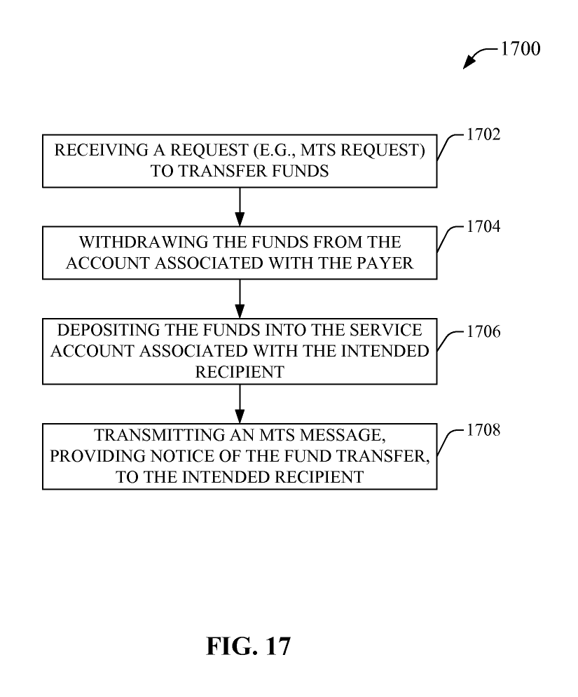

FIG. 17 depicts a flow chart of an example method 1700 for transferring funds associated with a service account associated with a payer in relation to an MTS in accordance with various aspects and embodiments. The method 1700 can be employed, for example, at least partially by a TMC when the payer's communication device and the intended recipient's communication interface each include MTS functionality. At 1702, a request to transfer funds (e.g., MTS request) can be received, for example, from the payer's communication device. The request can comprise information indicating or relating to the payer, intended recipient, address of the intended recipient, amount of funds to be transferred, account information associated with the payer and/or intended recipient, etc. In an aspect, the TMC can receive the request from the payer's communication device via a communication network.

At 1704, the funds to be transferred can be withdrawn (e.g., automatically) from the service account (e.g., mobile account) associated with the payer. In an aspect, the TMC can identify the service account (or other associated account) of the payer and can withdraw the amount of funds specified in the request from the service (or other) account. At 1706, the funds can be deposited (e.g., automatically) into the service account (e.g., mobile account) of the intended recipient. In an aspect, the TMC can deposit the funds withdrawn from the payer's service account into the intended recipient's service account. In another aspect, when specified by the user preferences of the intended recipient, the TMC can transfer all or part of the funds into another account associated with the intended recipient (e.g., withdraw all or a part of the deposited funds from the service account and deposit those funds in another account of the intended recipient in accordance with the user preferences of the intended recipient).

At 1708, an MTS message can be transmitted to the communication device of the intended recipient. In an aspect, the TMC can generate and transmit (e.g., automatically) an MTS message comprising information indicating or relating to identification and/or address information of the payer, identification and/or address information of the intended recipient, account information of the intended recipient, the amount of funds transferred to the service (or other) account of the intended recipient, and/or other information. The intended recipient can view and/or act on the MTS message, as more fully described herein (e.g., as described with regard to method 1800 or as otherwise described herein).

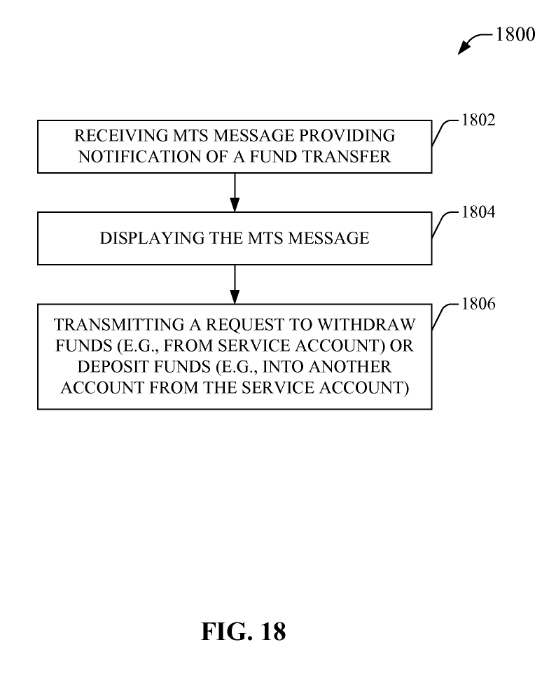

FIG. 18 illustrates a flow chart of an example method 1800 for receiving transferred funds associated with a service account (e.g., mobile account) of an intended recipient using an MTS (and related web or mobile MTS application) in accordance with various aspects and embodiments. The method 1800 can be employed, for example, at least partially by the intended recipient's communication interface, which can include MTS functionality, including a web or mobile MTS application. At 1802, an MTS message relating to a fund transfer to the service account of the intended recipient can be received, for example, by the intended recipient's communication device. The MTS message can comprise information identifying the payer and/or payer's address, identifying the intended recipient and/or associated address, amount of funds transferred to the intended recipient's service account, one or more controls that can be used to withdraw or obtain the transferred funds, and/or other information (e.g., a text message). In an aspect, the intended recipient's communication device can receive the MTS message from the TMC via the communication network.

At 1804, the MTS message can be displayed. For instance, the web or mobile MTS application associated with the intended recipient's communication device can provide a notification (e.g., notification icon or message, notification via an audio signal, notification via a device vibration, etc.) to the intended recipient. The MTS message can be automatically displayed on a UI of the application interface or can be displayed in response to input received from the intended recipient via the UI indicating that the MTS message is to be displayed.

At 1806, a request to withdraw or deposit funds can be transmitted, as desired. For instance, the intended recipient can select a control on a UI of the web or mobile MTS interface, for example, as presented in the MTS, to generate a request to withdraw funds (e.g., all or a portion of the transferred funds) from the service account of the intended recipient or deposit funds (e.g., move all or a portion of the transferred funds from the service account to another account of the intended recipient). The request can be transmitted from the intended recipient's communication device to the TMC via the communication network.

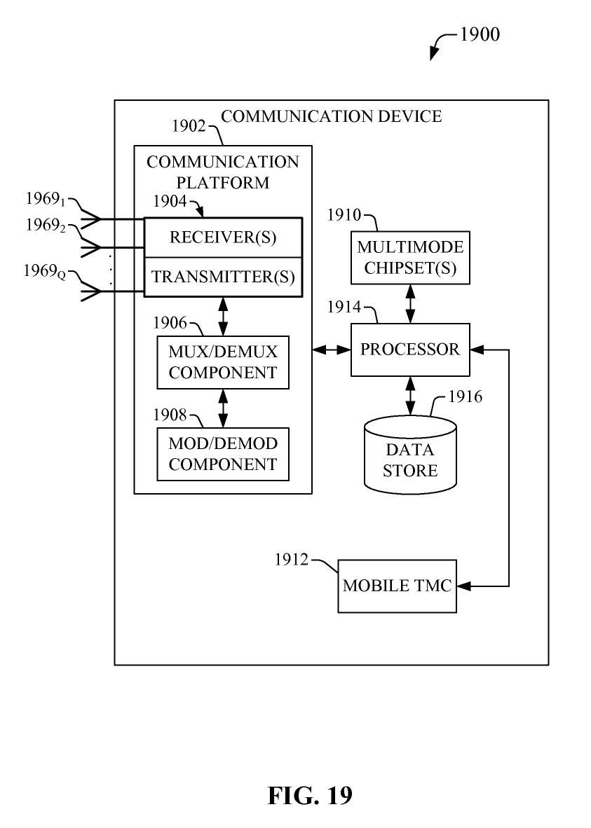

FIG. 19 depicts a block diagram of an example wireless communication device 1900 in accordance with various aspects and embodiments of the disclosed subject matter. In an aspect, the communication device 1900 can be a multimode access terminal, wherein a set of antennas 1969₁-1969_{Q} (Q is a positive integer) can receive and transmit signal(s) from and to wireless devices like access points, access terminals, wireless ports and routers, and so forth, that operate in a radio access network. It should be appreciated that antennas 1969₁-1969_{Q} are a part of communication platform 1902, which comprises electronic components and associated circuitry that provide for processing and manipulation of received signal(s) and signal(s) to be transmitted; e.g., receivers and transmitters 1904, multiplexer/demultiplexer (mux/demux) component 1906, and modulation/demodulation (mod/demod) component 1908.

In another aspect, the communication device 1900 can include a multimode operation chipset(s) 1910 that can allow the communication device 1900 to operate in multiple communication modes in accordance with disparate technical specification for wireless technologies. In an aspect, multimode operation chipset(s) 1910 can utilize communication platform 1902 in accordance with a specific mode of operation (e.g., voice, GPS). In another aspect, multimode operation chipset(s) 1910 can be scheduled to operate concurrently (e.g., when Q>1) in various modes or within a multitask paradigm.

In still another aspect, the communication device 1900 can comprise a mobile TMC 1912 that can be used to facilitate generating and transmitting fund transfer request (e.g., via an MTS), receiving fund transfer messages, and obtaining funds associated with a transfer of funds, as more fully described herein. The mobile TMC 1912 can operate in conjunction with regard to a TMC of the MTS with regard to fund transfer requests or can be employed to directly send a fund transfer message (e.g., comprising a link to accept transferred funds or a secure token comprising the transferred funds or information relating thereto) to a destination (e.g., communication device, email address) of an intended recipient.

In still another aspect, the communication device 1900 also can include a processor(s) 1914 that can be configured to confer functionality, at least in part, to substantially any electronic component within the communication device 1900, in accordance with aspects of the disclosed subject matter. For example, the processor(s) 1914 can facilitate enabling the communication device 1900 to process data (e.g., symbols, bits, or chips) for multiplexing/demultiplexing, modulation/demodulation, such as implementing direct and inverse fast Fourier transforms, selection of modulation rates, selection of data packet formats, inter-packet times, etc. As another example, the processor(s) 1914 can facilitate enabling the communication device 1900 to process data relating to fund transfer requests, fund transfer messages, secure tokens, validation or authorization codes, authentication credentials, and/or other data processes relating to processing financial transactions.

The communication device 1900 also can contain a data store 1916 that can store data structures (e.g., user data, metadata); code structure(s) (e.g., modules, objects, classes, procedures) or instructions; message hashes; neighbor cell list; information relating to fund transfer requests, fund transfer messages, secure tokens, validation or authorization codes, authentication credentials, and/or other data processes relating to processing financial transactions; network or device information like policies and specifications; attachment protocols; code sequences for scrambling, spreading and pilot (e.g., reference signal(s)) transmission; frequency offsets; cell IDs; encoding algorithms; compression algorithms; decoding algorithms; decompression algorithms; and so on. In an aspect, the processor(s) 1914 can be functionally coupled (e.g., through a memory bus) to the data store 1916 in order to store and retrieve information (e.g., neighbor cell list; information relating to mobile messaging, voice calls, or other services; frequency offsets; desired algorithms; etc.) desired to operate and/or confer functionality, at least in part, to the communication platform 1902, multimode operation chipset(s) 1910, mobile TMC 1912, and/or substantially any other operational aspects of the communication device 1900.

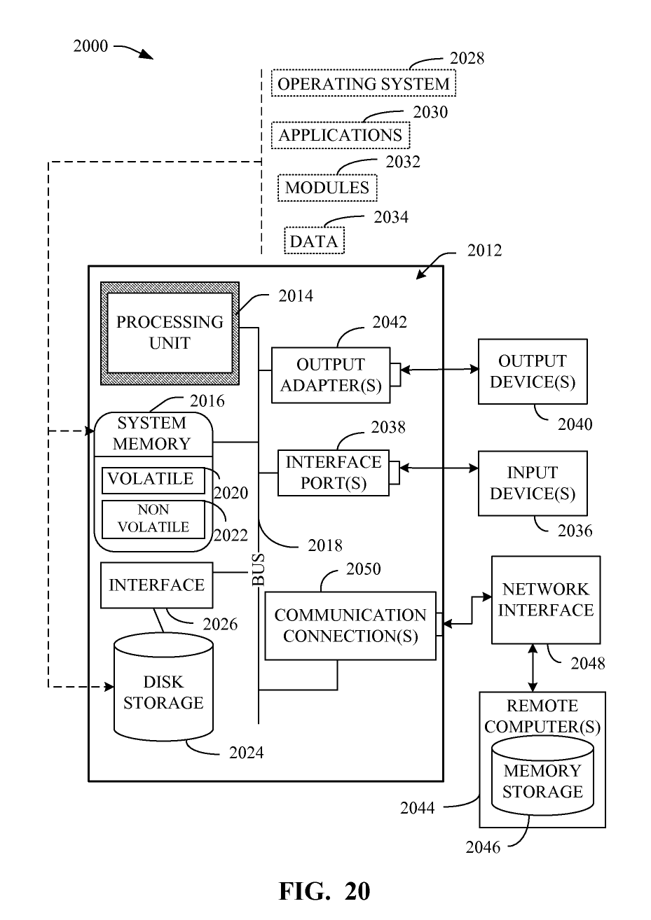

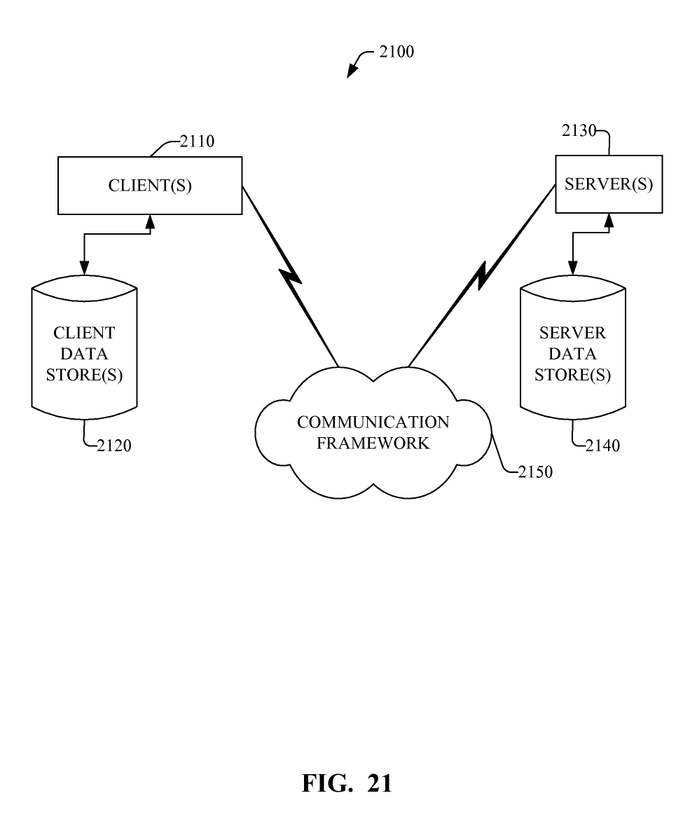

In order to provide a context for the various aspects of the disclosed subject matter, FIGS. 20 and 21 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the disclosed subject matter also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone), microprocessor-based or programmable consumer or industrial electronics, and the like. The illustrated aspects may also be practiced in distributed computing environments where tasks are performed by remote processing devices that are linked through a communications network. However, some, if not all aspects of the disclosed subject matter can be practiced on stand-alone computers. In a distributed computing environment, program modules may be located in both local and remote memory storage devices.

In accordance with various aspects and embodiments, the computer (e.g., 2012) can be a communication device that can be used to generate and send fund transfer requests or messages, or receive fund transfer messages, etc.; or can comprise a TMC that can be employed to receive and process fund transfer requests, manage service accounts of MTS users, or generate and send fund transfer messages, etc.

With reference to FIG. 20, a suitable environment 2000 for implementing various aspects of the disclosed subject matter includes a computer 2012. The computer 2012 includes a processing unit 2014, a system memory 2016, and a system bus 2018. The system bus 2018 couples system components including, but not limited to, the system memory 2016 to the processing unit 2014. The processing unit 2014 can be any of various available processors. Dual microprocessors and other multiprocessor architectures also can be employed as the processing unit 2014.

The system bus 2018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 2016 includes volatile memory 2020 and nonvolatile memory 2022. The basic input/output system (BIOS), containing the basic routines to transfer information between elements within the computer 2012, such as during start-up, is stored in nonvolatile memory 2022. By way of illustration, and not limitation, nonvolatile memory 2022 can include read only memory (ROM), programmable ROM (PROM), electrically programmable ROM (EPROM), electrically erasable programmable ROM (EEPROM), or flash memory. Volatile memory 2020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

The system memory 2016 includes volatile memory 2020 and nonvolatile memory 2022. The basic input/output system (BIOS), containing the basic routines to transfer information between elements within the computer 2012, such as during start-up, is stored in nonvolatile memory 2022. By way of illustration, and not limitation, nonvolatile memory 2022 can include read only memory (ROM), programmable ROM (PROM), electrically programmable ROM (EPROM), electrically erasable programmable ROM (EEPROM), or flash memory. Volatile memory 2020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

The system memory 2016 includes volatile memory 2020 and nonvolatile memory 2022. The basic input/output system (BIOS), containing the basic routines to transfer information between elements within the computer 2012, such as during start-up, is stored in nonvolatile memory 2022. By way of illustration, and not limitation, nonvolatile memory 2022 can include read only memory (ROM), programmable ROM (PROM), electrically programmable ROM (EPROM), electrically erasable programmable ROM (EEPROM), or flash memory. Volatile memory 2020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

The system memory 2016 includes volatile memory 2020 and nonvolatile memory 2022. The basic input/output system (BIOS), containing the basic routines to transfer information between elements within the computer 2012, such as during start-up, is stored in nonvolatile memory 2022. By way of illustration, and not limitation, nonvolatile memory 2022 can include read only memory (ROM), programmable ROM (PROM), electrically programmable ROM (EPROM), electrically erasable programmable ROM (EEPROM), or flash memory. Volatile memory 2020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 2012 also includes removable/non-removable, volatile/non-volatile computer storage media. FIG. 20 illustrates, for example, a disk storage 2024. Disk storage 2024 includes, but is not limited to, devices like a magnetic disk drive, floppy disk drive, tape drive, Jaz drive, Zip drive, LS-100 drive, flash memory card, or memory stick. In addition, disk storage 2024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 2024 to the system bus 2018, a removable or non-removable interface is typically used, such as interface 2026.

It is to be appreciated that FIG. 20 describes software that acts as an intermediary between users and the basic computer resources described in the suitable operating environment 2000. Such software includes an operating system 2028. Operating system 2028, which can be stored on disk storage 2024, acts to control and allocate resources of the computer system 2012. System applications 2030 take advantage of the management of resources by operating system 2028 through program modules 2032 and program data 2034 stored either in system memory 2016 or on disk storage 2024. It is to be appreciated that the claimed subject matter can be implemented with various operating systems or combinations of operating systems.

A user enters commands or information into the computer 2012 through input device(s) 2036. Input devices 2036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 2014 through the system bus 2018 via interface port(s) 2038. Interface port(s) 2038 include, for example, a serial port, a parallel port, a game port, and a universal serial bus (USB). Output device(s) 2040 use some of the same type of ports as input device(s) 2036. Thus, for example, a USB port may be used to provide input to computer 2012, and to output information from computer 2012 to an output device 2040. Output adapter 2042 is provided to illustrate that there are some output devices 2040 like monitors, speakers, and printers, among other output devices 2040, which require special adapters. The output adapters 2042 include, by way of illustration and not limitation, video and sound cards that provide a means of connection between the output device 2040 and the system bus 2018. It should be noted that other devices and/or systems of devices provide both input and output capabilities such as remote computer(s) 2044.

Computer 2012 can operate in a networked environment using logical connections to one or more remote computers, such as remote computer(s) 2044. The remote computer(s) 2044 can be a personal computer, a server, a router, a network PC, a workstation, a microprocessor based appliance, a peer device or other common network node and the like, and typically includes many or all of the elements described relative to computer 2012. For purposes of brevity, only a memory storage device 2046 is illustrated with remote computer(s) 2044. Remote computer(s) 2044 is logically connected to computer 2012 through a network interface 2048 and then physically connected via communication connection 2050. Network interface 2048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 2050 refers to the hardware/software employed to connect the network interface 2048 to the bus 2018. While communication connection 2050 is shown for illustrative clarity inside computer 2012, it can also be external to computer 2012. The hardware/software necessary for connection to the network interface 2048 includes, for exemplary purposes only, internal and external technologies such as, modems including regular telephone grade modems, cable modems and DSL modems, ISDN adapters, and Ethernet cards.

FIG. 21 is a schematic block diagram of a sample-computing environment 2100 with which the subject specification can interact. The system 2100 includes one or more client(s) 2110. The client(s) 2110 can be hardware and/or software (e.g., threads, processes, computing devices). The system 2100 also includes one or more server(s) 2130. Thus, system 2100 can correspond to a two-tier client server model or a multi-tier model (e.g., client, middle tier server, data server), amongst other models. The server(s) 2130 can also be hardware and/or software (e.g., threads, processes, computing devices). The servers 2130 can house threads to perform transformations by employing the disclosed subject matter, for example. One possible communication between a client 2110 and a server 2130 may be in the form of a data packet transmitted between two or more computer processes.

The system 2100 includes a communication framework 2150 that can be employed to facilitate communications between the client(s) 2110 and the server(s) 2130. The client(s) 2110 are operatively connected to one or more client data store(s) 2120 that can be employed to store information local to the client(s) 2110. Similarly, the server(s) 2130 are operatively connected to one or more server data store(s) 2140 that can be employed to store information local to the servers 2130.

It is to be appreciated and understood that components (e.g., communication device, communication network, TMC, mobile TMC, etc.), as described with regard to a particular system or method, can include the same or similar functionality as respective components (e.g., respectively named components or similarly named components) as described with regard to other systems or methods disclosed herein.

It is to be noted that aspects, features, and/or advantages of the disclosed subject matter can be exploited in substantially any wireless telecommunication or radio technology, e.g., Wi-Fi; Bluetooth; Worldwide Interoperability for Microwave Access (WiMAX); Enhanced General Packet Radio Service (Enhanced GPRS); Third Generation Partnership Project (3GPP) Long Term Evolution (LTE); Third Generation Partnership Project 2 (3GPP2) Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); GSM (Global System for Mobile Communications) EDGE (Enhanced Data Rates for GSM Evolution) Radio Access Network (GERAN); UMTS Terrestrial Radio Access Network (UTRAN); LTE Advanced (LTE-A); etc. Additionally, some or all of the aspects described herein can be exploited in legacy telecommunication technologies, e.g., GSM. In addition, mobile as well non-mobile networks (e.g., the Internet, data service network such as internet protocol television (IPTV), etc.) can exploit aspects or features described herein.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer readable storage media can include but are not limited to magnetic storage devices (e.g., hard disk, floppy disk, magnetic strips . . . ), optical discs (e.g., compact disc (CD), digital versatile disc (DVD), blu-ray disc (BD) . . . ), smart cards, and flash memory devices (e.g., card, stick, key drive . . . ), or the like.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

It is to be appreciated and understood that components (e.g., UE, AP, communication network, UE communication management component, notification communication management component, etc.), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

1. A system, comprising:
a communication device that is associated with a money transfer service and is configured to transmit a fund transfer message to a destination communication address associated with a payee to notify the payee of a fund transfer from a payer; and
a transfer management component that is associated with the communication device and is configured to receive a fund transfer request from a payer communication device associated with the payer, and generate the fund transfer message to facilitate an electronic transfer of a specified amount of funds from an account associated with the payer to the payee, without the payee having to be registered with the money transfer service, wherein the fund transfer request includes a digital image representative of the payer or the payee to facilitate authentication of the payee, and the transfer management component authenticates the payee based at least in part on receipt of a corresponding digital image of the payer or the payee, which is same as or similar to the digital image, from a payee communication device associated with the payee.

2. The system of claim 1, wherein the transfer management component is further configured to register the payer and associate a service account of the money transfer service with the payer, and the account from which the specified amount of funds is withdrawn is at least one of the service account or another account associated with the payer.

3. The system of claim 2, wherein the transfer management component is further configured to receive information from the payer communication device to manage the service account to at least one of add, remove, or modify information relating to, at least one of a debit account, a credit account, or a billing account, associated with the payer.

4. The system of claim 2, wherein the transfer management component is further configured to receive information from the payer communication device to select an account as at least one of a default withdraw account or a default deposit account, wherein, when the account is a default withdraw account, the transfer management component is configured to withdraw a specified amount of funds from the default withdraw account and deposit the specified amount of funds into the service account when the service account has an account balance that is below a predefined minimum threshold account balance, and wherein, when the account is a default deposit account, the transfer management component is configured to withdraw a particular amount of funds from the service account and deposit the particular amount of funds into the default deposit account when at least one of the service account contains the particular amount of funds or the service account has an account balance that is above a predefined maximum threshold account balance.

5. The system of claim 1, wherein the fund transfer request is generated via a web or mobile application associated with the money transfer service.

6. The system of claim 1, wherein the destination communication address is at least one of the payee communication device, an email in-box, or a voice mail in-box, associated with the payee.

7. The system of claim 1, wherein the fund transfer message is configured to comprise a link to an online page associated with the transfer management component, wherein the link is selectable to accept the specified amount of funds, and wherein the fund transfer message is one of a text message, an instant message, a multimedia message, or an email message.

8. The system of claim 1, wherein the payee is registered with the money transfer service, and the fund transfer message is configured to be generated to be viewable using a web or mobile application opened on the payee communication device, wherein the web or mobile application is associated with the transfer management component, and wherein the payee communication device is associated with the payee.

9. The system of claim 8, wherein the recipient payee communication device is configured to present the fund transfer message, the fund transfer message comprising information that indicates the specified amount of funds transferred to the payee per the fund transfer request.

10. The system of claim 1, wherein the fund transfer message is further configured to comprise a secure token containing the specified amount of funds.

11. The system of claim 10, wherein the secure token is configured to allow access to the specified amount of funds in response to receipt of valid authentication information by the secure token via the payee communication device associated with the payee.

12. The system of claim 1, wherein the transfer management component is further configured to control access to the account associated with the payer to grant access to the account when valid authentication credentials associated with the account are received and deny access to the account no valid authentication credentials associated with the account are received.

13. A method, comprising:
receiving, by a system including a processor, a fund transfer request from a first communication device, wherein the fund transfer request requests a specified amount of funds be withdrawn from an account associated with the first communication device and transferred to a destination communication address associated with an intended recipient; and
transmitting, by the system, a message, comprising information relating to the fund transfer request, to the destination communication address associated with the intended recipient to facilitate transferring the specified amount of funds to the intended recipient, based at least in part on authentication information received by a transfer management component from a second communication device associated with the intended recipient, notwithstanding the intended recipient not being registered with the transfer management component, wherein the fund transfer request includes a digital image known to the intended recipient to facilitate authenticating the intended recipient, and the authentication information includes a corresponding digital image that corresponds to the digital image contained in the fund transfer request.

14. The method of claim 13, further comprising:
selecting an account as at least one of a withdraw account or a deposit account;
linking the account to the service account;
setting at least one of a predefined minimum threshold account balance in relation to a default account or a predefined maximum threshold account balance in relation to the deposit account; and
at least one of:
withdrawing a first amount of funds from the withdraw account, and
depositing the first amount of funds into the service account in response to the service account having an account balance that is below the predefined minimum threshold account balance, or
withdrawing a second amount of funds from the service account, and
depositing the second amount of funds into the deposit account in response to at least one of the service account having the second amount of funds or the service account having an account balance that is above the predefined maximum threshold account balance.

15. The method of claim 13, further comprising:
receiving at least one of a request to withdraw funds or a request to deposit funds;
receiving information indicating an amount of funds to at least one of withdraw from a specified account or deposit to the specified account;
receiving information selecting the specified account, wherein the specified account is one of a debit account, a credit account, a billing account, or a service account, associated with the user associated with the at least one of the request to withdraw funds or the request to deposit funds; and
in response to the at least one of the request to withdraw funds or the request to deposit funds, at least one of:
withdrawing the amount of funds from the specified account, or
depositing the amount of funds into the specified account.

16. The method of claim 13, further comprising:
receiving a request to access an online page associated with the transfer management component based at least in part on selecting of a link in the fund transfer message by the intended recipient, wherein the link is to the online page, and the online page comprises information that facilitates obtaining of the specified amount of funds by the intended recipient;
presenting the online page to a second communication device associated with the intended recipient; and
at least one of depositing at least a portion of the specified funds into an account associated with the intended recipient or withdrawing at least a portion of the specified funds, based at least in part on instructions by the intended recipient.

17. The method of claim 13, further comprising:
receiving the fund transfer request from the first communication device, wherein the fund transfer request is a money-transfer-service fund transfer request;
withdrawing the specified amount of funds from the account associated with the first communication device;
transmitting the message to notify the intended recipient of the transferring of the specified amount of funds to the intended recipient, wherein the message is a money-transfer-service message, and wherein the intended recipient is registered with the money transfer service; and
depositing the specified amount of funds in a service account associated with the intended recipient.

18. The method of claim 17, further comprising:
receiving a transfer response request from the second communication device associated with the intended recipient, wherein the transfer response request comprises at least one of a request to withdraw at least a portion of the specified amount of funds or deposit at least a portion of the specified amount of funds into another account associated with the payee intended recipient; and
at least one of withdrawing the at least a portion of the specified amount of funds or depositing the at least a portion of the specified amount of funds into another account associated with the intended recipient, in response to the transfer response request.

19. The method of claim 13, further comprising:
receiving a selection of an option to manage an account in relation to a service account associated with a user registered with the transfer management component;
receiving at least one of selection of the account or information relating to the account; and
at least one of: linking the account to the service account when the account is being added to the service account, or unlinking the account from the service account when the account is being removed from the service account.

20. A computer program product comprising a computer readable storage medium having computer executable instructions stored thereon that, in response to execution, cause a computing system to perform operations, comprising:
receiving a fund transfer request from a first communication device, wherein the fund transfer request requests a specified amount of funds be withdrawn from an account associated with the first communication device and transferred to a destination communication address associated with an intended recipient; and
transmitting a message, comprising information relating to the fund transfer request, to the destination communication address associated with the intended recipient to facilitate transferring the specified amount of funds to the intended recipient, based at least in part on authentication information received by a transfer management component from a second communication device associated with the intended recipient, even if the intended recipient is not registered with the transfer management component, wherein the fund transfer request includes a digital image known to the intended recipient to facilitate authenticating the intended recipient, and the authentication information includes a corresponding digital image that corresponds to the digital image contained in the fund transfer request.

21. A communication device, comprising:
a user interface configured to display information associated with a transfer of funds to be processed by a money transfer service; and
a mobile transfer management component configured to generate and transmit a fund transfer request to transfer the funds from an account of a payer that is registered with the money transfer service to a destination communication address associated with a payee, wherein the fund transfer request is processed to transfer the funds to the payee irrespective of whether the payee is registered with the money transfer service, wherein the fund transfer request includes a digital image known to the payee to facilitate authentication of the payee by a device associated with the money transfer service based at least in part on authentication information received by the device from a second communication device associated with the payee, and the authentication information includes a corresponding digital image that corresponds to the digital image contained in the fund transfer request.

22. The communication device of claim 21, wherein the mobile transfer management component is further configured to receive selection of an option to transfer the funds as part of the fund transfer request, receive selection of the payee from a contact list of the payer, receive selection of an amount of the funds to be transferred, and receive a command to transmit the fund transfer request to the money transfer service, wherein the fund transfer request comprises information that relates to the payee and the amount of funds to be transferred to the payee.

23. The communication device of claim 21, wherein the fund transfer request is generated using at least one of a money transfer service application interface or a message interface.

24. The communication device of claim 23, wherein the message interface facilitates generation of at least one of a text message, an instant message, a multimedia message, or an email message, comprising the fund transfer request.

25. The communication device of claim 21, wherein the mobile transfer management component is further configured to generate a management request that relates to management of a service account of the payer with the money transfer service, select a specified account, select one of a link option to link the specified account to the service account or an unlink option to unlink the specified account from the service account, and transmit the management request, in response to information received from the payer.

26. The communication device of claim 21, wherein the mobile transfer management component is further configured to, as part of a default account request, select and set an account as at least one of a default withdraw account or a default deposit account, and transmit the default account request to a transfer management component associated with the money transfer service, wherein, when the account is a default withdraw account, the transfer management component is configured to withdraw a specified amount of funds from the default withdraw account and deposit the specified amount of funds into the service account when the service account has an account balance that is below a predefined minimum threshold account balance, and wherein, when the account is a default deposit account, the transfer management component is configured to withdraw a particular amount of funds from the service account and deposit the particular amount of funds into the default deposit account when at least one of the service account contains the particular amount of funds or the service account has an account balance that is above a predefined maximum threshold account balance.
